(19) United States
(12) Patent Application Publication
(10) Pub. No.: US 2014/0127463 A1
(43) Pub. Date: May 8, 2014

(54) ARTICLE HAVING MICRO UNEVEN STRUCTURE ON SURFACE THEREOF AND VIDEO DISPLAY DEVICE HAVING THE SAME

(71) Applicants: Go Otani, Hiroshima (JP); Hiroshi Onomoto, Hiroshima (JP); Seiichiro Mori, Hiroshima (JP)

(72) Inventors: Go Otani, Hiroshima (JP); Hiroshi Onomoto, Hiroshima (JP); Seiichiro Mori, Hiroshima (JP)

(73) Assignee: MITSUBISHI RAYON CO., LTD., TOKYO (JP)

(21) Appl. No.: 14/130,324

(22) PCT Filed: Jul. 4, 2012
(86) PCT No.: PCT/JP2012/067072

§ 371 Date: Dec. 31, 2013

(30) Foreign Application Priority Data
Jul. 5, 2011 (JP) 2011-149117
Jul. 5, 2011 (JP) 2011-149118
Mar. 12, 2012 (JP) 2012-054451

(51) Int. Cl. G02B 1/11; B32B 27/16; B32B 3/30

(52) U.S. Cl. CPC G02B 1/118; B32B 3/30; B32B 27/16
USPC 428/141; 359/601

(57) ABSTRACT

Provided is an article having a micro uneven structure on a surface thereof, wherein the article is obtained by forming a micro uneven structure composed of a cured product of a solvent-free active energy ray curable resin composition on a substrate containing triacetylcellulose, wherein an average interval between two adjacent convex parts in the micro uneven structure is less than or equal to a visible light wavelength, and adhesion between the substrate containing triacetylcellulose and a layer composed of the cured product of the active energy ray curable resin composition is classified into any one of type 0 to 2 according to a crosscut method defined in ISO2409:1992 (JIS K 5600-5-6:1999).

### TECHNICAL FIELD

The invention relates to an article having a micro uneven structure on a surface thereof and to a video display device having the article.

The present application claims the priority benefits of Japanese patent application no. 2011-149117 filed on Jul. 5, 2011, Japanese patent application no. 2011-149118 filed on Jul. 5, 2011, and Japanese patent application no. 2012-054451 filed on Mar. 12, 2012. The entirety of each of the above-mentioned patent applications is hereby incorporated by reference herein and made a part of this specification.

### BACKGROUND ART

It is known that an article having a micro uneven structure with a period of less than or equal to a visible light wavelength on a surface thereof has an antireflection function due to continuous variation in a refractive index of the micro uneven structure. It is also known that the micro uneven structure exhibits ultra water repellency by a lotus effect.

As manufacturing methods of the article having a micro uneven structure on a surface thereof, the following methods, for example, are proposed.

(i) a method of transferring a micro uneven structure onto thermoplastic resin when injection-molding or press-molding the thermoplastic resin using a mold having an inversion structure of the micro uneven structure on a surface thereof;

(ii) a method of filling an active energy ray curable resin composition between a mold having an inversion structure of a micro uneven structure on a surface thereof and a light transmissive substrate, curing the active energy ray curable resin composition by irradiation with an active energy ray, and then releasing the mold to transfer the micro uneven structure onto a cured product; or a method of releasing the mold after filling the active energy ray curable resin composition between the mold and the light transmissive substrate, so as to transfer the micro uneven structure onto the active energy ray curable resin composition, and then curing the active energy ray curable resin composition by irradiation with an active energy ray.

Among these methods, in terms of good transfer property of the micro uneven structure, high flexibility in constitution of the surface of the article, and additionally, excellent productivity since continuous production is possible when the mold is a belt or a roll, the method (ii) attracts attention.

As the active energy ray curable resin composition used in the method (ii), the following compositions, for example, are proposed.

(1) a photocurable resin composition containing an acrylate oligomer such as urethane acrylate and so on, acrylic resin having a free radical polymerizable functional group, a mold release agent, and a photoinitiator (Patent Document 1);

(2) a photocurable resin composition containing (meth)acrylate such as ethoxylated bisphenol A di(meth)acrylate and so on, a reactive diluent such as N-vinylpyrrolidone and so on, a photoinitiator and a fluoro-based surfactant (Patent Document 2);

(3) an ultraviolet-curable resin composition containing polyfunctional (meth)acrylate such as trimethylolpropanetri(meth)acrylate and so on, a photoinitiator, and a levelling agent such as polyether-modified silicone oil and so on (Patent Document 3).

As mentioned above, since the article having a micro uneven structure on a surface thereof has the antireflection function, in most cases, it is used for optical purposes, such as being used by being adhered to a front (surface) of a video display device such as a liquid-crystal display or the like. At this moment, it is preferable that there is no difference in refractive index between the light transmissive substrate that composes the article having a micro uneven structure on a surface thereof and a body to be adhered (such as a polarizing plate of the liquid-crystal display), i.e. the light transmissive substrate and the body to be adhered are composed of the same material, or include the same material.

In recent years, triacetylcellulose (TAC) film has received attention as a protective film of the polarizing plate of the liquid-crystal display. In the case of adhering the article having a micro uneven structure on a surface thereof to the TAC film that serves as the protective film of the polarizing plate, it is preferable to use a substrate containing TAC (such as the TAC film and so on) as the light transmissive substrate. In addition, in the case of disposing a front panel, touch panel or the like on the liquid-crystal display, and adhering the article having a micro uneven structure on a surface thereof to a portion thereof, in terms of light transmissive property or optical uniformity, birefringence and so on, it is also preferable to use the substrate containing TAC (such as the TAC film and so on) as the light transmissive substrate.

However, in the case of employing the resin compositions of (1) to (3) to the substrate containing TAC, it was difficult to sufficiently ensure adhesion between the cured product of the active energy ray curable resin composition and the substrate. Accordingly, there was a need for adding the following step: disposing on a surface of the substrate a layer for ensuring the adhesion with the cured product, or performing a surface treatment on the substrate.

In the case of forming a layer composed of the cured product of the active energy ray curable resin composition on the TAC film with good adhesion, a solvent is usually used for diluting the active energy ray curable resin composition. For example, an ultraviolet-curable resin composition containing polyfunctional acrylate esters such as dipentaerythritol hexaacrylate and so on and a reactive monomer containing nitrogen atoms is diluted with a solvent such as toluene or the like, and then coated on the TAC film. Following removal of the solvent, the resultant is irradiated with ultraviolet ray to be cured, thereby obtaining a hard coat layer adhered to the TAC film (Patent Document 4).

In addition, as another method of forming the layer composed of the cured product of the active energy ray curable resin composition on the TAC film with good adhesion, the following method is provided: forming a primer layer on the TAC film, coating the active energy ray curable resin composition thereon and curing it, thereby forming a hard coat layer including the cured product (Patent Document 5).

### PRIOR ART DOCUMENTS

### Patent Documents

Patent Document 1: Japanese Patent Gazette No. 4156415

Patent Document 2: Japanese Patent Publication No. 2007-84625

Patent Document 3: Japanese Patent Publication No. 2000-71290

Patent Document 4: Japanese Patent Gazette No. 3989037

Patent Document 5: Japanese Patent Gazette No. 3466250

### SUMMARY OF THE INVENTION

### Problems to be Solved by the Invention

As described in Patent Document 4, the method of diluting the active energy ray curable resin composition for use with the solvent utilizes the following effect: coating the active energy ray curable resin composition on the TAC film using the solvent and drying it, by which the reactive monomer permeates into the TAC film. For that reason, the use of the solvent contributes significantly to securing of the adhesion with respect to the TAC film.

However, in the case of manufacturing the article having a micro uneven structure on a surface thereof, in order to perform a precise transfer of the micro uneven structure, it is preferable that the active energy ray curable resin composition is used without dilution with the solvent. For that reason, it is actually difficult to manufacture the article having a micro uneven structure on a surface thereof using the active energy ray curable resin composition that has been diluted with the solvent.

In addition, in the method described in Patent Document 5, in order to form the primer layer on TAC, steps such as coating, drying, aging and so on are required, which led to a problem of increased processing cost.

Accordingly, there is demand for an article in which the substrate containing TAC is sufficiently adhered with the cured product of the active energy ray curable resin composition having a micro uneven structure.

In addition, in the case of manufacturing the article by filling the active energy ray curable resin composition between the mold and the light transmissive substrate, curing the composition by irradiation with the active energy ray, and then releasing the mold to transfer the micro uneven structure onto the cured product, it is also required that the obtained article be easily released from the mold. Particularly, in the case of manufacturing the article having a micro uneven structure with a period of less than or equal to a visible light wavelength on a surface thereof, sometimes it is not easy for the article to be released from the mold, and thus the article is also required to have excellent mold releasability.

In addition, in regard to the article, as mentioned above, since it is used for optical purposes in most cases, it is also required to be excellent in optical properties such as antireflection function or light transmissive property.

A purpose of the invention is to provide an article having a micro uneven structure on a surface thereof and a video display device having the article, wherein the article is obtained by sufficiently adhering a substrate containing triacetylcellulose with a cured product of an active energy ray curable resin composition having a micro uneven structure.

In addition, another purpose of the invention is to provide an article having a micro uneven structure on a surface thereof and a video display device having the article, wherein the article is obtained by sufficiently adhering a substrate containing triacetylcellulose with a cured product of an active energy ray curable resin composition having a micro uneven structure, and the article has excellent optical properties.

Furthermore, another purpose of the invention is to provide an article having a micro uneven structure on a surface thereof and a video display device having the article, wherein the article is obtained by sufficiently adhering a substrate containing triacetylcellulose with a cured product of an active energy ray curable resin composition having a micro uneven structure, and the article has good releasability from the mold.

### Means for Solving the Problems

A first aspect of the invention has the following characteristics.

<1> An article having a micro uneven structure on a surface thereof, wherein the article is obtained by forming a micro uneven structure composed of a cured product of a solvent-free active energy ray curable resin composition on a substrate containing triacetylcellulose; and wherein an average interval between two adjacent convex parts in the micro uneven structure is less than or equal to a visible light wavelength, and adhesion between the substrate containing triacetylcellulose and a layer composed of the cured product of the active energy ray curable resin composition is classified into any one of type 0 to 2 according to a crosscut method defined in ISO2409:1992 (JIS K 5600-5-6:1999).

A second aspect of the invention has the following characteristics.

<2> The article having a micro uneven structure on a surface thereof as described in the above <1>, wherein the active energy ray curable resin composition contains a polymerizable component (X) and a photoinitiator (E), wherein the polymerizable component (X) contains 30-60 mass % of a polyfunctional monomer (A), 30-60 mass % of a bifunctional monomer (B) and 5-30 mass % of a monomer (C1), wherein the polyfunctional monomer (A) has 3 or more free radical polymerizable functional groups in a molecule and each functional group thereof has a molecular weight of 150 or less, the bifunctional monomer (B) has 2 free radical polymerizable functional groups in a molecule and 4 or fewer oxyalkylene groups in the molecule, and the monomer (C1) is at least one selected from a group consisting of γ-butyrolactone acrylate, 2-hydroxyethyl acrylate, N,N-dimethylacrylamide, N,N-diethylacrylamide, oxazolidone-N-ethyl acrylate, methyl acrylate and ethyl acrylate.

A third aspect of the invention has the following characteristics.

<3> The article having a micro uneven structure on a surface thereof as described in the above <1>, wherein the active energy ray curable resin composition contains a polymerizable component (X), a photoinitiator (E), and an internal mold release agent (F), wherein the polymerizable component (X) contains 30-49.99 mass % of a polyfunctional monomer (A), 30-40 mass % of a bifunctional monomer (B), 20-30 mass % of a monomer (C2) and 0.01-10 mass % of a monomer (D), wherein the polyfunctional monomer (A) has 3 or more free radical polymerizable functional groups in a molecule and each functional group thereof has a molecular weight of 150 or less, the bifunctional monomer (B) has 2 free radical polymerizable functional groups in a molecule and 4 or fewer oxyalkylene groups in the molecule, the monomer (C2) has 1 or more free radical polymerizable functional groups in a molecule and a morpholine skeleton in the molecule, and the monomer (D) has 1 or more free radical polymerizable functional groups in a molecule and a silicone skeleton in the molecule, and wherein the internal mold release agent (F) contains a (poly)oxyalkylene alkyl phosphate compound.

A fourth aspect of the invention has the following characteristics.

<4> The article having a micro uneven structure on a surface thereof as described in the above <1>, wherein the active energy ray curable resin composition contains a polymerizable component (X), a photoinitiator (E), and an internal mold release agent (F), wherein the polymerizable component (X) contains 30-60 mass % of a polyfunctional monomer (A), 20-60 mass % of a bifunctional monomer (B), 5-30 mass % of a monomer (C3) and 0.01-10 mass % of a monomer (D), wherein the polyfunctional monomer (A) has 3 or more free radical polymerizable functional groups in a molecule and each functional group thereof has a molecular weight of 150 or less, the bifunctional monomer (B) has 2 free radical polymerizable functional groups in a molecule and 4 or fewer oxyalkylene groups in the molecule, the monomer (C3) has 1 or more acrylamide groups in a molecule, and the monomer (D) has 1 or more free radical polymerizable functional groups in a molecule and a silicone skeleton in the molecule, and wherein the internal mold release agent (F) contains a (poly)oxyalkylene alkyl phosphate compound.

A fifth aspect of the invention has the following characteristics.

<5> The article having a micro uneven structure on a surface thereof as described in the above <1> to <4>, wherein the article is an antireflective article.

A sixth aspect of the invention has the following characteristics.

<6> A video display device including a video display device main body and one or more of the article having a micro uneven structure on a surface thereof as described in the above <1> to <5>, wherein the article is disposed at a front of a screen of the video display device main body.

### Effects of the Invention

According to the article having a micro uneven structure on a surface thereof as the first aspect of the invention, the substrate containing triacetylcellulose is sufficiently adhered with the cured product of the active energy ray curable resin composition having a micro uneven structure.

According to the article having a micro uneven structure on a surface thereof as the second aspect of the invention, the substrate containing triacetylcellulose is sufficiently adhered with the cured product of the active energy ray curable resin composition having a micro uneven structure, and the article has excellent optical properties.

According to the article having a micro uneven structure on a surface thereof as the third aspect of the invention, the substrate containing triacetylcellulose is sufficiently adhered with the cured product of the active energy ray curable resin composition having a micro uneven structure, and the article has good releasability from a mold.

According to the article having a micro uneven structure on a surface thereof as the fourth aspect of the invention, the substrate containing triacetylcellulose is sufficiently adhered with the cured product of the active energy ray curable resin composition having a micro uneven structure, and the article has good releasability from a mold.

According to the article having a micro uneven structure on a surface thereof as the fifth aspect of the invention, the substrate containing triacetylcellulose is sufficiently adhered with the cured product of the active energy ray curable resin composition having a micro uneven structure, and the article is suitable for use as an antireflective article.

According to the video display device as the sixth aspect of the invention, one or more of the article having a micro uneven structure are disposed on a surface thereof disposed at the front of the screen of the video display device main body, and in the article, the substrate containing triacetylcellulose is sufficiently adhered with the cured product of the active energy ray curable resin composition having a micro uneven structure.

### BRIEF DESCRIPTION OF THE DRAWINGS

FIG. 1 is a cross-sectional view of an example of an article having a micro uneven structure on a surface thereof.

FIG. 2 is a cross-sectional view of a manufacturing process of a mold having anodized alumina on a surface thereof.

FIG. 3 is a structure view of an example of a manufacturing device for the article having a micro uneven structure on a surface thereof.

### DETAILED DESCRIPTION OF DISCLOSED EMBODIMENTS

The invention is described in detail below.

Moreover, in this specification, “free radical polymerizable functional group” refers to (meth)acryloyl group, vinyl group and so on. In addition, “(meth)acryloyl group” refers to acryloyl group and/or methacryloyl group. In addition, “(meth)acrylate” refers to acrylate and/or methacrylate. In addition, “active energy ray” refers to visible ray, ultraviolet ray, electron beam, plasma, heat ray (infrared ray and so on) and so on.

“Article having a micro uneven structure on a surface thereof”

The article having a micro uneven structure on a surface thereof in the invention is an article obtained by forming a micro uneven structure on a substrate containing triacetylcellulose (hereinafter, triacetylcellulose is referred to as “TAC,” and the substrate containing triacetylcellulose is referred to as “TAC substrate”), wherein the micro uneven structure is composed of a cured product of a solvent-free active energy ray curable resin composition.

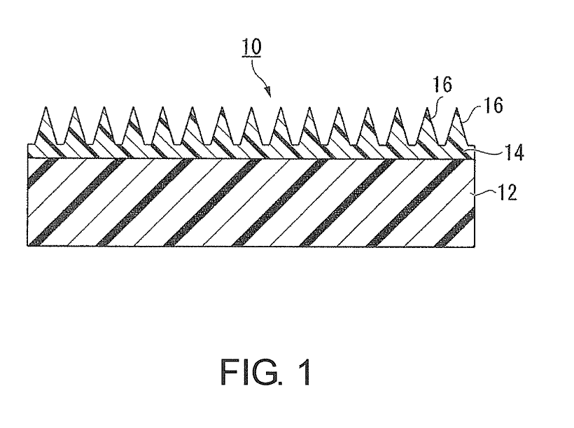

FIG. 1 is a cross-sectional view of an example of the article having a micro uneven structure on a surface thereof.

In the present example, the article having a micro uneven structure on a surface thereof (hereinafter sometimes simply referred to as “article”) 10 includes a TAC substrate 12 and a cured resin layer 14 formed on a surface of the TAC substrate 12.

Moreover, the article 10 may be obtained by forming a micro uneven structure on the whole surface, or by foaming a micro uneven structure on a portion of the surface. Particularly in the case where the article 10 is shaped as a film, the micro uneven structure may be formed on the whole surface of the surface, or the micro uneven structure may be formed on a portion of the surface. In addition, a micro uneven structure may or may not be formed on another surface.

The TAC substrate 12 is preferably a formed body that transmits light. A shape of the TAC substrate 12 may be a film shape, or a sheet shape, or a three-dimensional shape. For example, in the case where the article 10 is made film-shaped, a film-shaped TAC substrate is used. A TAC film is particularly suitable.

The TAC substrate 12 preferably contains TAC as a main component, or it may be composed of only TAC, or may properly contain, in addition to TAC, various additives such as plasticizer or ultraviolet absorber, lubricant and so on. In addition, it may also contain similar cellulose modified products.

In addition, the surface of the TAC substrate 12 may be treated by a corona treatment, a plasma treatment, a blasting treatment and so on for improving adhesion, antistatic properties, scratch resistance, weather resistance and so on.

The cured resin layer 14 is a film (layer) composed of a cured product of a later-described active energy ray curable resin composition, and has a micro uneven structure on a surface thereof.

In the case of using a later-described mold of anodized alumina, the micro uneven structure on the surface of the article 10 is formed by transferring a micro uneven structure on a surface of anodized alumina, and includes a plurality of convex parts 16 formed of the cured product of the active energy ray curable resin composition.

The micro uneven structure is preferably a so-called moth-eye structure formed by arranging a plurality of protrusions (convex parts) having a substantially conical shape, a pyramid shape and so on. It is known that the moth-eye structure in which an interval between the protrusions is less than or equal to the visible light wavelength becomes an effective antireflection means as the refractive indices keep increasing continuously from the refractive index of air to the refractive index of the material.

An average interval between two adjacent convex parts is preferably less than or equal to the visible light wavelength, i.e. 400 nm or less. If the average interval is more than 400 nm, scattering of visible light occurs, which is disadvantageous to optical applications such as antireflective articles. In the case of forming the convex parts using the later-described mold of anodized alumina, the average interval between the convex parts becomes about 100 nm. Thus, the average interval is more preferably 200 nm or less, and especially preferably 150 nm or less.

In terms of ease of forming a convex part, the average interval between the convex parts is preferably 20 nm or more.

The average interval between the convex parts is obtained by measuring the interval between adjacent convex parts (distance from the center of a convex part to the center of an adjacent convex part) at 50 locations through electron microscope observation, and then calculating an average of measured values.

A height of the convex part is preferably 80 nm to 500 nm, more preferably 120 nm to 400 nm, and especially preferably 150 nm to 300 nm. If the height of the convex part is 80 nm or more, reflectivity is sufficiently reduced, and wavelength dependence of the reflectivity is little. If the height of the convex part is 500 nm or less, the scratch resistance of the convex part becomes good. In the case where the average interval between the convex parts is around 100 nm, the situation is the same.

The height of the convex part is a value obtained by measuring a distance between an uppermost portion of the convex part and a lowermost portion of a concave part existing between convex parts by observation with an electron microscope at a magnification of 30,000 times.

An aspect ratio of the convex part (the height of the convex part/the average interval between the convex parts) is preferably 0.8 to 5, more preferably 1.2 to 4, and especially preferably 1.5 to 3. If the aspect ratio of the convex part is 1.0 or more, the reflectivity becomes sufficiently low. If the aspect ratio of the convex part is 5 or less, the scratch resistance of the convex part becomes good.

A shape of the convex part is preferably a shape in which a cross-sectional area of the convex part in a direction orthogonal to a height direction increases continuously in a depth direction from an uppermost surface, i.e. a shape in which a cross-sectional shape of the convex part in the height direction is a triangular shape, trapezoidal shape, bell shape or the like.

A difference between a refractive index of the cured resin 14 and a refractive index of the TAC substrate 12 is preferably 0.2 or less, more preferably 0.1 or less, and especially preferably 0.05 or less. If the difference in refractive index is 0.2 or less, reflection on an interface between the cured resin layer 14 and the TAC substrate 12 is suppressed.

In regard to the article having a micro uneven structure on a surface thereof as the first aspect of the invention, the adhesion between the TAC substrate and the layer composed of the cured product of the active energy ray curable resin composition is classified into any one of type 0 to 2 according to the crosscut method defined in ISO2409:1992 (JIS K 5600-5-6:1999). Therefore, in the article having a micro uneven structure on a surface thereof as the first aspect of the invention, the TAC substrate is sufficiently adhered with the cured product of the active energy ray curable resin composition having a micro uneven structure.

Moreover, a test using the crosscut method may be carried out on the article having a micro uneven structure on a surface thereof, but is not limited thereto. For example, a specimen as follows may also be used for carrying out the crosscut method. The specimen is obtained by coating the active energy ray curable resin composition on the TAC substrate and curing it, and then by forming the layer composed of the cured product on the TAC substrate. In the specimen in this case, a micro uneven structure is not formed on a surface of the layer composed of the cured product of the active energy ray curable resin composition.

In order to classify the adhesion between the TAC substrate and the layer composed of the cured product of the active energy ray curable resin composition into any one of type 0 to 2 according to the crosscut method defined in ISO2409:1992 (JIS K 5600-5-6:1999), the active energy ray curable resin composition shown as follows, for example, may be used.

<Active Energy Ray Curable Resin Composition>

The so-called active energy ray curable resin composition refers to a resin composition polymerized and cured by irradiation with the active energy ray.

The active energy ray curable resin composition is solvent-free. “Solvent-free” means substantially not containing an organic solvent. Specifically, in 100 mass % of the active energy ray curable resin composition, the content of the organic solvent is preferably 5.0 mass % or less, more preferably 1.0 mass % or less, and further preferably none at all.

By means of the solvent-free active energy ray curable resin composition, a precise transfer of a micro uneven structure may be performed.

In the article having a micro uneven structure on a surface thereof as the second aspect of the invention, the active energy ray curable resin composition used has a polymerizable component (X) and a photoinitiator (E) as essential components.

The above active energy ray curable resin composition may also contain an internal mold release agent (F), an ultraviolet absorber and/or an antioxidant (G), and other components, depending on requirements.

In terms of ease of flowing to the micro uneven structure on a surface of a mold, viscosity of the active energy ray curable resin composition is preferably not excessively high. Accordingly, the viscosity of the active energy ray curable resin composition measured at 25° C. using a rotary B type viscometer is preferably 10,000 mPa·s or less, more preferably 5,000 mPa·s or less, and further preferably 2,000 mPa·s or less.

However, even if the viscosity of the active energy ray curable resin composition is more than 10,000 mPa·s, as long as the viscosity is reduced by preheating in contact with the mold, there will be no particular problem. In this case, the viscosity of the active energy ray curable resin composition measured at 70° C. using the rotary B type viscometer is preferably 5,000 mPa·s or less, and more preferably 2,000 mPa·s or less.

(Polymerizable Component (X))

The polymerizable component (X) has a specific polyfunctional monomer (A), a specific bifunctional monomer (B) and a specific monomer (C1) as essential components, and may contain other polymerizable components (except for the polyfunctional monomer (A), the bifunctional monomer (B) and the monomer (C1)) depending on requirements.

(Polyfunctional Monomer (A))

The polyfunctional monomer (A) has 3 or more free radical polymerizable functional groups in a molecule and each functional group thereof has a molecular weight of 150 or less.

A molecular weight of each functional group refers to a value obtained by dividing a molecular weight of the polyfunctional monomer (A) by a number of the free radical polymerizable functional groups in a molecule.

For example, in the case of trimethylolpropane triacrylate as a representative trifunctional monomer, its molecular weight is 296, and the number of free radical polymerizable functional groups is 3. Thus, the molecular weight of each functional group is 98.67, which is less than or equal to 150.

By means of the polyfunctional monomer (A) having 3 or more free radical polymerizable functional groups in a molecule and each functional group thereof having a molecular weight of 150 or less, the following effects are exhibited: a crosslinking density of the whole polymerizable component (X) is ensured, and elastic modulus or hardness of the cured product is increased. Accordingly, a micro uneven shape is retained, and optical properties are maintained even during a heat test or a high temperature and humidity test.

The molecular weight of each functional group of the polyfunctional monomer (A) is preferably 120 or less.

Examples of the polyfunctional monomer (A) include tri- or higher functional (meth)acrylate in which each functional group has a molecular weight of 150 or less.

Examples of such polyfunctional monomer (A) include pentaerythritol tri(meth)acrylate, pentaerythritol tetra(meth)acrylate, dipentaerythritol penta(meth)acrylate, dipentaerythritol hexa(meth)acrylate, tripentaerythritol octa(meth)acrylate, trimethylol propane tri(meth)acrylate, ditrimethylol propane tetra(meth)acrylate, a condensation reaction mixture having a molar ratio of succinic acid/trimethylolethane/acrylic acid of 1:2:4, isocyanuric acid tri(meth)acrylate, glycerin tri(meth)acrylate and alkylene oxide modified products thereof, urethane acrylates, polyether acrylates, modified epoxy acrylates, polyester acrylates and so on.

One kind of the polyfunctional monomer (A) may be used alone, or two or more kinds thereof may be used in combination.

A proportion of the polyfunctional monomer (A) in the polymerizable component (X) is 30-60 mass %, and preferably 40-50 mass %. If the proportion of the polyfunctional monomer (A) is less than 30 mass %, there may be cases where the elastic modulus or hardness of the cured product is decreased, the micro uneven shape cannot be retained, and the optical properties deteriorate. On the other hand, if the proportion of the polyfunctional monomer (A) is more than 60 mass %, the elastic modulus of the cured product is increased, which may cause cracks in the cured product when the mold is released from the cured product.

In addition, since the cured product becomes hard and brittle, there may be cases where cracks occur during a durability test or a thermal cycle test or a heat shock test, a weather resistance test and so on. When cracks occur in the cured product, the optical properties easily deteriorate.

(Bifunctional Monomer (B))

The bifunctional monomer (B) is a compound having 2 free radical polymerizable functional groups in a molecule, and having 4 or fewer oxyalkylene groups in a molecule.

Moreover, in the case where the bifunctional monomer (B) is a mixture of several compounds having different numbers of oxyalkylene groups, the number of oxyalkylene groups is set to an average value thereof.

By combination with the later-described monomer (C1), the bifunctional monomer (B) contributes to improvement in the adhesion of the cured product to the TAC substrate and viscosity reduction of the polymerizable component (X).

As the number of oxyalkylene groups in the bifunctional monomer (B) is decreased, the molecular weight is decreased, permeability to the TAC substrate is increased, and the adhesion is improved. Accordingly, the number of oxyalkylene groups in the bifunctional monomer (B) is 4 or fewer. If the number of oxyalkylene groups in the bifunctional monomer (B) is more than 4, the adhesion of the cured product to the TAC substrate is reduced.

Examples of the oxyalkylene group in the bifunctional monomer (B) include oxyethylene group, oxypropylene group, oxybutylene group and so on. Among them, in terms of excellence in the adhesion to the TAC substrate, oxyethylene group is preferable.

Examples of the bifunctional monomer (B) include (meth)acrylate having 2 free radical polymerizable functional groups in a molecule, and having 4 or fewer oxyalkylene groups in a molecule.

Examples of such bifunctional monomer (B) include: ethylene glycol diacrylate, diethylene glycol di(meth)acrylate, triethylene glycol di(meth)acrylate, tetraethylene glycol di(meth)acrylate, polyethylene glycol di(meth)acrylate, propylene glycol di(meth)acrylate, dipropylene glycol di(meth)acrylate, tripropylene glycol di(meth)acrylate, tetrapropylene glycol di(meth)acrylate, polypropylene glycol di(meth)acrylate, 1,4-butanediol diacrylate, dibutylene glycol di(meth)acrylate, tributylene glycol di(meth)acrylate, tetrabutylene glycol di(meth)acrylate, polybutylene glycol di(meth)acrylate, 1,6-hexanediol di(meth)acrylate, 1,9-nonanediol di(meth)acrylate and so on.

One kind of the bifunctional monomer (B) may be used alone, or two or more kinds thereof may be used in combination.

A proportion of the bifunctional monomer (B) in the polymerizable component (X) is 30-60 mass %, and preferably 35-45 mass %. If the proportion of the bifunctional monomer (B) is less than 30 mass %, the adhesion to the TAC substrate is reduced. On the other hand, if the proportion of the bifunctional monomer (B) is more than 60 mass %, the shape of the convex part in the micro uneven structure is hard to retain, or the cured product of the active energy ray curable resin composition is easily whitened due to bonding (unification) of adjacent convex parts, and the optical properties deteriorate. In addition, there may also be cases where the optical properties cannot be maintained during a heat test or a high temperature and humidity test.

(Monomer (C1))

The monomer (C1) is at least one monomer (compound) selected from a group consisting of γ-butyrolactone acrylate, 2-hydroxyethyl acrylate, N,N-dimethylacrylamide, N,N-diethylacrylamide, oxazolidone-N-ethyl acrylate, methyl acrylate and ethyl acrylate.

In combination with the above bifunctional monomer (B), the monomer (C1) contributes to improvement in the adhesion to the TAC substrate and viscosity reduction of the polymerizable component (X).

Specifically, the monomer (C1) is at least one monomer selected from a group consisting of compounds represented by the following formulas (c1) to (c7).

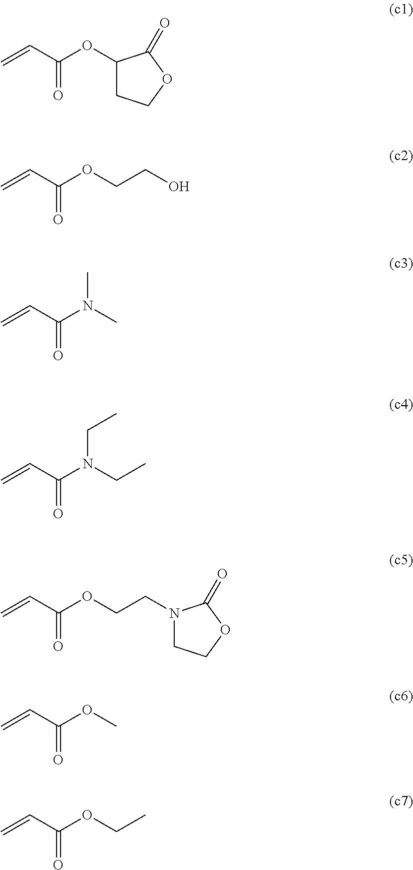

Moreover, the compounds represented by the formulas (c1) to (c7) correspond respectively to compounds as follows.

Formula (c1): γ-butyrolactone acrylate;

Formula (c2): 2-hydroxyethyl acrylate;

Formula (c3): N,N-dimethylacrylamide;

Formula (c4): N,N-diethylacrylamide;

Formula (c5): oxazolidone-N-ethyl acrylate;

Formula (c6): methyl acrylate;

Formula (c7): ethyl acrylate.

One kind of the monomer (C1) may be used alone, or two or more kinds thereof may be used in combination.

A proportion of the monomer (C1) in the polymerizable component (X) is 5-30 mass %, and preferably 10-25 mass %. If the proportion of the monomer (C1) is less than 5 mass %, the adhesion to the TAC substrate is reduced. On the other hand, if the proportion of the monomer (C1) is more than 30 mass %, rigidity of the convex part in the micro uneven structure is reduced, the shape of the convex part is hard to retain, and the optical properties deteriorate. In addition, there may also be cases where the optical properties cannot be maintained during a heat test or a high temperature and humidity test.

(Other Polymerizable Components)

Within a scope of not damaging the effects of the invention, the polymerizable component (X) may contain other polymerizable components in addition to the polyfunctional monomer (A), the bifunctional monomer (B) and the monomer (C1). Examples of other polymerizable components include: bi- or higher functional monomers other than the polyfunctional monomer (A) and the bifunctional monomer (B), oligomers or polymers having a free radical polymerizable functional group, and so on.

A proportion of the other polymerizable components in the polymerizable component (X) is preferably 30 mass % or less, more preferably 20 mass % or less, and especially preferably 10 mass % or less. That is, a total amount of the polyfunctional monomer (A), the bifunctional monomer (B) and the monomer (C1) in the polymerizable component (X) is preferably 70 mass % or more.

(Photoinitiator (E))

The so-called photoinitiator (E) refers to a compound that is cleaved by irradiation with the active energy ray to generate a radical that initiates a polymerization reaction. In terms of equipment costs or productivity, the active energy ray is preferably ultraviolet ray.

Examples of the photoinitiator (E) that generates a radical by irradiation with ultraviolet ray, namely, examples of the photoinitiator include benzophenone, 4,4-bis(diethylamino)benzophenone, 2,4,6-trimethylbenzophenone, methyl orthobenzoyl benzoate, 4-phenylbenzophenone, t-butylanthraquinone, 2-ethylanthraquinone, thioxanthones (2,4-diethylthioxanthone, isopropylthioxanthone, 2,4-dichlorothioxanthone and so on), acetophenones (diethoxyacetophenone, 2-hydroxy-2-methyl-1-phenylpropan-1-one, benzyldimethylketal, 1-hydroxycyclohexyl-phenylketone, 2-methyl-2-morpholino(4-thiomethylphenyl)propan-1-one, 2-benzyl-2-dimethylamino-1-(4-morpholinophenyl)butanone and so on), benzoin ethers (benzoin methyl ether, benzoin ethyl ether, benzoin isopropyl ether, benzoin isobutyl ether and so on), acylphosphine oxides (2,4,6-trimethylbenzoyl diphenyl phosphine oxide, bis(2,6-dimethoxybenzoyl)-2,4,4-trimethylpentyl phosphine oxide, bis(2,4,6-trimethylbenzoyl)-phenyl phosphine oxide and so on), methylbenzoyl formate, 1,7-bisacrydinylheptane, 9-phenylacrydine and so on.

One kind of the photoinitiator (E) may be used alone, or two or more kinds thereof may be used in combination. In the case of combination, it is preferable that two or more kinds having different absorption wavelengths are used in combination.

In addition, depending on requirements, thermal polymerization initiators such as persulfate (potassium persulfate, ammonium persulfate and so on), peroxide (benzoyl peroxide and so on), azo initiators and so on may be used in combination.

Relative to 100 mass parts of the polymerizable component (X), the proportion of the photoinitiator (E) is preferably 0.01-10 mass parts, more preferably 0.1-5 mass parts, and further preferably 0.2-3 mass parts. If the proportion of the photoinitiator (E) is less than 0.01 mass part, there may be cases where curing of the active energy ray curable resin composition is not completed, leading to damage to mechanical properties of the article having a micro uneven structure on a surface thereof. On the other hand, if the proportion of the photoinitiator (E) is more than 10 mass parts, there may be cases where non-reacted photoinitiator (E) remains in the cured product and functions as a plasticizer, leading to decreases in the elastic modulus of the cured product and damaging the scratch resistance. In addition, there may be cases where coloring is caused.

(Internal Mold Release Agent (F))

The above active energy ray curable resin composition may further contain an internal mold release agent (F).

As long as the internal mold release agent (F) is compatible with the active energy ray curable resin composition and provides the releasability from a mold, there is no particular limitation on its composition.

Examples of the internal mold release agent (F) include (poly)oxyalkylene alkyl phosphate compounds. The (poly)oxyalkylene alkyl phosphate compound is adhered to the surface of the mold, and has an effect of increasing continuous transfer property by exhibiting the mold releasability on an interface with the active energy ray curable resin composition and the cured product thereof. Particularly in the case of using the later-described mold of anodized alumina, the (poly)oxyalkylene alkyl phosphate compound interacts with alumina so that the internal mold release agent (F) is easily adhered to the surface of the mold.

In terms of excellent mold releasability, the (poly)oxyalkylene alkyl phosphate compound is preferably a compound represented by the following formula (f1).

(HO)₃₋ₙ(O═)P[—O—(CH₂CH₂O)ₘ—R¹]ₙ (f1)

R¹ is an alkyl group, m is an integer of 1 to 20, and n is an integer of 1 to 3.

R¹ is preferably a C1-20 alkyl group, and more preferably a C3-18 alkyl group.

m is preferably an integer of 1 to 10.

The (poly)oxyalkylene alkyl phosphate compound is any one of a monoester (n=1), a diester (n=2) or a triester (n=3). In addition, in the case of a diester or a triester, multiple (poly)oxyalkylene alkyl groups in a molecule may be different from one another.

Examples of commercial products of the (poly)oxyalkylene alkyl phosphate compound include “JP-506H” manufactured by Johoku Chemical Co., Ltd., “MoldWiz INT-1856” manufactured by Axel Plastics Research Laboratories, Inc., “TDP-10,” “TDP-8,” “TDP-6,” “TDP-2,” “DDP-10,” “DDP-8,” “DDP-6,” “DDP-4,” “DDP-2,” “TLP-4,” “TCP-5” and “DLP-10” manufactured by Nikko Chemicals Co., Ltd., and so on.

One kind of the internal mold release agent (F) may be used alone, or two or more kinds thereof may be used in combination.

Relative to 100 mass parts of the polymerizable component (X), the proportion of the internal mold release agent (F) is preferably 0.01-2.0 mass parts, and preferably 0.05-0.2 mass part. If the proportion of the internal mold release agent (F) is less than 0.01 mass part, there is a fear that the releasability of the article having a micro uneven structure on a surface thereof from the mold becomes insufficient. On the other hand, if the proportion of the internal mold release agent (F) is more than 2.0 mass %, the adhesion between the cured product of the active energy ray curable resin composition and the TAC substrate worsens, or the cured product softens, so that there is a fear that the micro uneven structure cannot be retained.

(Ultraviolet Absorber and/or Antioxidant (G))

The above active energy ray curable resin composition may further contain an ultraviolet absorber and/or an antioxidant (G), and so on.

Examples of the ultraviolet absorber include: benzophenone-based, benzotriazole-based, hindered amine-based, benzoate-based, triazine-based and so on. Examples of commercial products include: ultraviolet absorbers such as “Tinuvin 400” or “Tinuvin 479” manufactured by Chiba Specialty Chemicals, “Viosorb 110” manufactured by Kyodo Chemical Co., Ltd., and so on.

Examples of the antioxidant include: hindered phenol-based antioxidants, benzimidazole-based antioxidants, phosphorus-based antioxidants, sulfur-based antioxidants, hindered amine-based antioxidants and so on. Examples of commercial products include “IRGANOX” series manufactured by Chiba Specialty Chemicals, and so on.

One kind of these ultraviolet absorbers and antioxidants (G) may be used alone, or two or more kinds thereof may be used in combination.

Relative to 100 mass parts of the polymerizable component (X), the proportion of a total amount of the ultraviolet absorber and/or the antioxidant (G) is preferably 0.01-5 mass parts.

(Other Components)

Depending on requirements, the above active energy ray curable resin composition may also contain well-known additives such as plasticizer, antistatic agent, light stabilizer, flame retardant, flame retardant assistant, polymerization inhibitor, filler, silane coupling agent, colorant, reinforcing agent, inorganic filler, impact modifier and so on.

In addition, depending on requirements, the above active energy ray curable resin composition may also contain oligomers or polymers having no free radical polymerizable functional group, a minor amount (specifically, 5.0 mass % or less in 100 mass % of the active energy ray curable resin composition) of organic solvent and so on.

The above-described article having a micro uneven structure on a surface thereof as the second aspect of the invention is an article in which a micro uneven structure is formed on a TAC substrate, wherein the micro uneven structure includes a cured product of an active energy ray curable resin composition, wherein the active energy ray curable resin composition contains 30-60 mass % of the above polyfunctional monomer (A), 30-60 mass % of the above bifunctional monomer (B) and 5-30 mass % of the above monomer (C1). The cured product of the active energy ray curable resin composition has excellent adhesion to the TAC substrate, and well retains the micro uneven structure.

Therefore, in regard to the article having a micro uneven structure on a surface thereof as the second aspect of the invention, the TAC substrate is sufficiently adhered with the cured product of the active energy ray curable resin composition having a micro uneven structure, and good optical properties are provided. In addition, after various durability tests, the micro uneven structure may still be well retained.

In addition, according to the second aspect of the invention, even if no primer layer is disposed on the TAC substrate, an article in which the TAC substrate is sufficiently adhered with the cured product may be manufactured easily and inexpensively.

In the article having a micro uneven structure on a surface thereof as the third aspect of the invention, the active energy ray curable resin composition used has a polymerizable component (X), a photoinitiator (E), and an internal mold release agent (F) as essential components.

The above active energy ray curable resin composition may also contain an ultraviolet absorber and/or an antioxidant (G), and other components, depending on requirements.

In terms of ease of flowing to the micro uneven structure on a surface of a mold, viscosity of the active energy ray curable resin composition is preferably not excessively high. Accordingly, the viscosity of the active energy ray curable resin composition measured at 25° C. using a rotary B type viscometer is preferably 10,000 mPa·s or less, more preferably 5,000 mPa·s or less, and further preferably 2,000 mPa·s or less.

However, even if the viscosity of the active energy ray curable resin composition is more than 10,000 mPa·s, as long as the viscosity is reduced by preheating in contact with the mold, there will be no particular problem. In this case, the viscosity of the active energy ray curable resin composition measured at 70° C. using the rotary B type viscometer is preferably 5,000 mPa·s or less, and more preferably 2,000 mPa·s or less. (Polymerizable component (X))

The polymerizable component (X) has a specific polyfunctional monomer (A), a specific bifunctional monomer (B), a specific monomer (C2) having a morpholine skeleton, and a specific monomer (D) having a silicone skeleton as essential components.

The above polymerizable component (X) may contain other polymerizable components (except for the polyfunctional monomer (A), the bifunctional monomer (B), the monomer (C2) and the monomer (D)) depending on requirements.

(Polyfunctional Monomer (A))

The polyfunctional monomer (A) has 3 or more free radical polymerizable functional groups in a molecule and each functional group thereof has a molecular weight of 150 or less.

A molecular weight of each functional group refers to a value obtained by dividing a molecular weight of the polyfunctional monomer (A) by a number of the free radical polymerizable functional groups in a molecule.

By means of the polyfunctional monomer (A) having 3 or more free radical polymerizable functional groups in a molecule and each functional group thereof having a molecular weight of 150 or less, the following effects are exhibited: a crosslinking density of the whole polymerizable component (X) is ensured, and elastic modulus or hardness of the cured product is increased. Accordingly, a micro uneven shape is retained, and optical properties are maintained even during a heat test or a high temperature and humidity test.

The molecular weight of each functional group of the polyfunctional monomer (A) is preferably 120 or less.

Examples of the polyfunctional monomer (A) include tri- or higher functional (meth)acrylate in which each functional group has a molecular weight of 150 or less.

Examples of such polyfunctional monomer (A) include the polyfunctional monomer (A) exemplified in the description of the active energy ray curable resin composition used in the article having a micro uneven structure on a surface thereof as the second aspect of the invention.

One kind of the polyfunctional monomer (A) may be used alone, or two or more kinds thereof may be used in combination.

The proportion of the polyfunctional monomer (A) in the polymerizable component (X) is 30-49.99 mass %, and preferably 40-45 mass %. If the proportion of the polyfunctional monomer (A) is less than 30 mass %, there may be cases where the elastic modulus or hardness of the cured product is decreased, and the micro uneven shape cannot be retained. On the other hand, if the proportion of the polyfunctional monomer (A) is more than 49.99 mass %, the elastic modulus of the cured product is increased, which may cause cracks in the cured product when the mold is released from the cured product. In addition, since the cured product becomes hard and brittle, there may be cases where cracks occur during a durability test or a thermal cycle test or a heat shock test, a weather resistance test and so on.

(Bifunctional Monomer (B))

The bifunctional monomer (B) is a compound having 2 free radical polymerizable functional groups in a molecule, and having 4 or fewer oxyalkylene groups in a molecule.

Moreover, in the case where the bifunctional monomer (B) is a mixture of several compounds having different numbers of oxyalkylene groups, the number of oxyalkylene groups is set to an average value thereof.

By combination with the later-described monomer (C2), the bifunctional monomer (B) contributes to improvement in the adhesion of the cured product to the TAC substrate and viscosity reduction of the polymerizable component (X).

As the number of oxyalkylene groups in the bifunctional monomer (B) is decreased, the molecular weight is decreased, the permeability to the TAC substrate is increased, and the adhesion is improved. Accordingly, the number of oxyalkylene groups in the bifunctional monomer (B) is 4 or fewer. If the number of oxyalkylene groups in the bifunctional monomer (B) is more than 4, the adhesion of the cured product to the TAC substrate is reduced.

Examples of the oxyalkylene group in the bifunctional monomer (B) include oxyethylene group, oxypropylene group, oxybutylene group and so on. Among them, in terms of excellence in the adhesion to the TAC substrate, oxyethylene group is preferable.

Examples of the bifunctional monomer (B) include (meth)acrylate having 2 free radical polymerizable functional groups in a molecule, and having 4 or fewer oxyalkylene groups in a molecule.

Examples of such bifunctional monomer (B) include the bifunctional monomer (B) exemplified in the description of the active energy ray curable resin composition used in the article having a micro uneven structure on a surface thereof as the second aspect of the invention.

One kind of the bifunctional monomer (B) may be used alone, or two or more kinds thereof may be used in combination.

The proportion of the bifunctional monomer (B) in the polymerizable component (X) is 30-40 mass %, and preferably 30-35 mass %. If the proportion of the bifunctional monomer (B) is less than 30 mass %, the adhesion to the TAC substrate is reduced. On the other hand, if the proportion of the bifunctional monomer (B) is more than 40 mass %, there may be cases where the shape of the convex part in the micro uneven structure is hard to retain, or the optical properties cannot be maintained during a heat test or a high temperature and humidity test.

((Monomer (C2))

The monomer (C2) is a compound having 1 or more free radical polymerizable functional groups in a molecule, and having a morpholine skeleton in a molecule.

By combination with the above bifunctional monomer (B), the monomer (C2) contributes to improvement in the adhesion to the TAC substrate and viscosity reduction of the polymerizable component (X).

Examples of the monomer (C2) includes compounds having 1 or more (meth)acryloyl groups in a molecule, and having a morpholine skeleton in a molecule.

Examples of such monomer (C2) include (meth)acryloyl morpholine and so on.

One kind of the monomer (C2) may be used alone, or two or more kinds thereof may be used in combination.

A proportion of the monomer (C2) in the polymerizable component (X) is 20-30 mass %, and preferably 20-25 mass %. If the proportion of the monomer (C2) is less than 20 mass %, the adhesion to the TAC substrate is reduced. On the other hand, if the proportion of the monomer (C2) is more than 30 mass %, there may be cases where the rigidity of the convex part in the micro uneven structure is reduced, the shape of the convex part is hard to retain, or the optical properties cannot be maintained during a heat test or a high temperature and humidity test.

(Monomer (D))

The monomer (D) is a compound having 1 or more free radical polymerizable functional groups in a molecule, and having a silicone skeleton in a molecule.

By combination with the bifunctional monomer (B) and the monomer (C2), the monomer (D) provides the adhesion of the cured product of the active energy ray curable resin composition to the TAC substrate, and the releasability from the mold having a micro uneven structure.

While the monomer (C2) contributes to the adhesion to the TAC substrate as mentioned above, the monomer (C2) causes deterioration in the releasability of the cured product of the active energy ray curable resin composition from the mold having a micro uneven structure. Accordingly, by making the active energy ray curable resin composition contain the monomer (D), the releasability from the mold may be exhibited while the adhesion to the TAC substrate is maintained.

Moreover, in a use of the bifunctional monomer (B) alone or the monomer (C2) alone, sufficient adhesion cannot be obtained.

There is no particular limitation on the monomer (D) as long as it has 1 or more free radical polymerizable functional groups and a silicone skeleton in a molecule. Examples thereof include: acryloyl group-containing polyester-modified polydimethylsiloxane, acryloyl group-containing polyether-modified polydimethylsiloxane and so on.

In addition, commercial products may be used as the monomer (D). Examples thereof include: “BYK-UV3500” and “BYK-UV3570” manufactured by BYK Japan KK, “TEGO Rad 2010,” “TEGO Rad 2011,” “TEGO Rad 2100,” “TEGO Rad 2200N,” “TEGO Rad 2250,” “TEGO Rad 2300,” “TEGO Rad 2500,” “TEGO Rad 2600,” “TEGO Rad 2650” and “TEGO Rad 2700” manufactured by Evonik Degussa Japan Co., Ltd., “X-22-1602” and “X-22-2445” manufactured by Shin-Etsu Chemical Co., Ltd., and so on.

One kind of the monomer (D) may be used alone, or two or more kinds thereof may be used in combination.

A proportion of the monomer (D) in the polymerizable component (X) is 0.01-10 mass %, and preferably 0.1-5 mass %. If the proportion of the monomer (D) is less than 0.01 mass %, the releasability of the article having a micro uneven structure on a surface thereof from the mold becomes insufficient. On the other hand, if the proportion of the monomer (D) is more than 10 mass %, the adhesion between the TAC substrate and the cured product is reduced, or the active energy ray curable resin composition easily becomes cloudy.

(Other Polymerizable Components)

Within a scope of not damaging the effects of the invention, the polymerizable component (X) may contain other polymerizable components in addition to the polyfunctional monomer (A), the bifunctional monomer (B), the monomer (C2) and the monomer (D). Examples of other polymerizable components include: bi- or higher functional monomers other than the polyfunctional monomer (A) and the bifunctional monomer (B), oligomers or polymers having a free radical polymerizable functional group, and so on.

A proportion of the other polymerizable components in the polymerizable component (X) is preferably 30 mass % or less, more preferably 20 mass % or less, and especially preferably 10 mass % or less. That is, a total amount of the polyfunctional monomer (A), the bifunctional monomer (B), the monomer (C2) and the monomer (D) in the polymerizable component (X) is preferably 70 mass % or more.

(Photoinitiator (E))

The so-called photoinitiator (E) refers to a compound that is cleaved by irradiation with the active energy ray to generate a radical that initiates a polymerization reaction. In terms of equipment cost or productivity, the active energy ray is preferably ultraviolet ray.

Examples of the photoinitiator (E) that generates a radical by irradiation with ultraviolet ray, namely, examples of the photoinitiator include the photoinitiator (E) exemplified in the description of the active energy ray curable resin composition used in the article having a micro uneven structure on a surface thereof as the second aspect of the invention.

One kind of the photoinitiator (E) may be used alone, or two or more kinds thereof may be used in combination. In the case of combination, it is preferable that two or more kinds having different absorption wavelengths are used in combination.

In addition, depending on requirements, thermal polymerization initiators such as persulfate (potassium persulfate, ammonium persulfate and so on), peroxide (benzoyl peroxide and so on), azo initiators and so on may be used in combination.

Relative to 100 mass parts of the polymerizable component (X), the proportion of the photoinitiator (E) is preferably 0.01-10 mass parts, more preferably 0.1-5 mass parts, and further preferably 0.2-3 mass parts. On the other hand, if the proportion of the photoinitiator (E) is less than 0.01 mass part, there may be cases where curing of the active energy ray curable resin composition is not completed, leading to damage to the mechanical properties of the article having a micro uneven structure on a surface thereof. If the proportion of the photoinitiator (E) is more than 10 mass parts, there may be cases where non-reacted photoinitiator (E) remains in the cured product and functions as a plasticizer, leading to decrease in the elastic modulus of the cured product and damage to the scratch resistance. In addition, there may be cases where coloring is caused.

(Internal Mold Release Agent (F))

The internal mold release agent (F) is a component required for maintaining good mold releasability when continuously manufacturing the article in the third aspect of the invention. It contains a (poly)oxyalkylene alkyl phosphate compound and is adhered to the surface of the mold, and has an effect of increasing the continuous transfer property by exhibiting the mold releasability on the interface with the active energy ray curable resin composition and the cured product thereof. Particularly in the case of using the later-described mold of anodized alumina, the (poly)oxyalkylene alkyl phosphate compound interacts with alumina so that the internal mold release agent (F) is easily adhered to the surface of the mold.

In terms of excellent mold releasability, the (poly)oxyalkylene alkyl phosphate compound is preferably a compound represented by the above formula (f1).

Examples of commercial products of the (poly)oxyalkylene alkyl phosphate compound include the commercial products of the (poly)oxyalkylene alkyl phosphate compound exemplified in the description of the active energy ray curable resin composition used in the article having a micro uneven structure on a surface thereof as the second aspect of the invention.

One kind of the internal mold release agent (F) may be used alone, or two or more kinds thereof may be used in combination.

Relative to 100 mass parts of the polymerizable component (X), the proportion of the internal mold release agent (F) is preferably 0.01-2.0 mass parts, and preferably 0.05-0.2 mass part. If the proportion of the internal mold release agent (F) is less than 0.01 mass part, there is a fear that the releasability of the article having a micro uneven structure on a surface thereof from the mold becomes insufficient. On the other hand, if the proportion of the internal mold release agent (F) is more than 2.0 mass %, the adhesion between the cured product of the active energy ray curable resin composition and the TAC substrate worsens, or the cured product softens, so that the micro uneven structure cannot be retained.

(Ultraviolet Absorber and/or Antioxidant (G))

The active energy ray curable resin composition may further contain an ultraviolet absorber and/or an antioxidant (G), and so on.

Examples of the ultraviolet absorber and the antioxidant include the ultraviolet absorber and the antioxidant (G) exemplified in the description of the active energy ray curable resin composition used in the article having a micro uneven structure on a surface thereof as the second aspect of the invention.

One kind of these ultraviolet absorbers and antioxidants (G) may be used alone, or two or more kinds thereof may be used in combination.

Relative to 100 mass parts of the polymerizable component (X), the proportion of a total amount of the ultraviolet absorber and/or the antioxidant (G) is preferably 0.01-5 mass parts.

(Other Components)

Depending on requirements, the above active energy ray curable resin composition may also contain well-known additives such as plasticizer, antistatic agent, light stabilizer, flame retardant, flame retardant assistant, polymerization inhibitor, filler, silane coupling agent, colorant, reinforcing agent, inorganic filler, impact modifier and so on.

In addition, depending on requirements, the above active energy ray curable resin composition may also contain oligomers or polymers having no free radical polymerizable functional group, a minor amount (specifically, 5.0 mass % or less in 100 mass % of the active energy ray curable resin composition) of organic solvent and so on.

The above-described article having a micro uneven structure on a surface thereof as the third aspect of the invention is an article in which a micro uneven structure is formed on a TAC substrate, wherein the micro uneven structure includes a cured product of an active energy ray curable resin composition, wherein the active energy ray curable resin composition contains 30-49.99 mass % of the above polyfunctional monomer (A), 30-40 mass % of the above bifunctional monomer (B), 20-30 mass % of the above monomer (C2), 0.01-10 mass % of the above monomer (D), and the internal mold release agent (F) containing a (poly)oxyalkylene alkyl phosphate compound. The cured product of the active energy ray curable resin composition is provided with both the adhesion to the TAC substrate and the releasability from the mold for transferring a micro uneven structure.

Therefore, in regard to the article having a micro uneven structure on a surface thereof as the third aspect of the invention, the TAC substrate is sufficiently adhered with the cured product of the active energy ray curable resin composition having a micro uneven structure, and good releasability from the mold are provided. In addition, after various durability tests, the micro uneven structure may still be well retained.

In addition, according to the third aspect of the invention, even if no primer layer is disposed on the TAC substrate, an article in which the TAC substrate is sufficiently adhered with the cured product may be manufactured easily and inexpensively.

In the article having a micro uneven structure on a surface thereof as the fourth aspect of the invention, the active energy ray curable resin composition used has a polymerizable component (X), a photoinitiator (E), and an internal mold release agent (F) as essential components.

The above active energy ray curable resin composition may also contain an ultraviolet absorber and/or an antioxidant (G), and other components, depending on requirements.

In terms of ease of flowing to the micro uneven structure on a surface of a mold, viscosity of the active energy ray curable resin composition is preferably not excessively high. Accordingly, the viscosity of the active energy ray curable resin composition measured at 25° C. using a rotary B type viscometer is preferably 10,000 mPa·s or less, more preferably 5,000 mPa·s or less, and further preferably 2,000 mPa·s or less.

However, even if the viscosity of the active energy ray curable resin composition is more than 10,000 mPa·s, as long as the viscosity is reduced by preheating in contact with the mold, there will be no particular problem. In this case, the viscosity of the active energy ray curable resin composition measured at 70° C. using a rotary B type viscometer is preferably 5,000 mPa·s or less, and more preferably 2,000 mPa·s or less. (Polymerizable component (X))

The polymerizable component (X) has later-described specific polyfunctional monomer (A), specific bifunctional monomer (B), specific monomer (C3) and specific monomer (D) as essential components, and may contain other polymerizable components (except for the polyfunctional monomer (A), the bifunctional monomer (B), the monomer (C3) and the monomer (D)) depending on requirements.

(Polyfunctional Monomer (A))

The polyfunctional monomer (A) has 3 or more free radical polymerizable functional groups in a molecule and each functional group thereof has a molecular weight of 150 or less.

A molecular weight of each functional group refers to a value obtained by dividing a molecular weight of the polyfunctional monomer (A) by a number of the free radical polymerizable functional groups in a molecule.

By means of the polyfunctional monomer (A) having 3 or more free radical polymerizable functional groups in a molecule and each functional group thereof having a molecular weight of 150 or less, the following effects are exhibited: a crosslinking density of the whole polymerizable component (X) is ensured, and elastic modulus or hardness of the cured product is increased. Accordingly, a micro uneven shape is retained, and optical properties are maintained even during a heat test or a high temperature and humidity test.

The molecular weight of each functional group of the polyfunctional monomer (A) is preferably 120 or less.

Examples of the polyfunctional monomer (A) include tri- or higher functional (meth)acrylate in which each functional group has a molecular weight of 150 or less.

Examples of such polyfunctional monomer (A) include the polyfunctional monomer (A) exemplified in the description of the active energy ray curable resin composition used in the article having a micro uneven structure on a surface thereof as the second aspect of the invention.

One kind of the polyfunctional monomer (A) may be used alone, or two or more kinds thereof may be used in combination.

A proportion of the polyfunctional monomer (A) in the polymerizable component (X) is 30-60 mass %, and preferably 40-50 mass %. If the proportion of the polyfunctional monomer (A) is 30 mass % or more, a micro uneven shape may be retained, and the elastic modulus and hardness of the cured product for obtaining the required optical properties may be achieved. On the other hand, if the proportion of the polyfunctional monomer (A) is 60 mass % or less, since the elastic modulus of the cured product does not become excessively high, no crack occurs in the cured product when the mold is released from the cured product.

In addition, if the elastic modulus of the cured product becomes excessively high, the cured product becomes hard and brittle, and there may be cases where cracks occur during a durability test or a thermal cycle test or a heat shock test, or a weather resistance test and so on. When cracks occur in the cured product, the optical properties easily deteriorate.

(Bifunctional Monomer (B))

The bifunctional monomer (B) is a compound having 2 free radical polymerizable functional groups in a molecule, and having 4 or fewer oxyalkylene groups in a molecule.

Moreover, in the case where the bifunctional monomer (B) is a mixture of several compounds having different numbers of oxyalkylene groups, the number of oxyalkylene groups is set to an average value thereof.

By combination with the later-described monomer (C3), the bifunctional monomer (B) contributes to improvement in the adhesion of the cured product to the TAC substrate and viscosity reduction of the polymerizable component (X).

As the number of oxyalkylene groups in the bifunctional monomer (B) is decreased, the molecular weight is decreased, the permeability to the TAC substrate is increased, and the adhesion is improved. Accordingly, the number of oxyalkylene groups in the bifunctional monomer (B) is 4 or fewer. If the number of oxyalkylene groups in the bifunctional monomer (B) is more than 4, the adhesion of the cured product to the TAC substrate is reduced.

Examples of the oxyalkylene group in the bifunctional monomer (B) include oxyethylene group, oxypropylene group, oxybutylene group and so on. Among them, in terms of excellence in the adhesion to the TAC substrate, oxyethylene group is preferable.

Examples of the bifunctional monomer (B) include (meth)acrylate having 2 free radical polymerizable functional groups in a molecule, and having 4 or fewer oxyalkylene groups in a molecule.

Examples of such bifunctional monomer (B) include the bifunctional monomer (B) exemplified in the description of the active energy ray curable resin composition used in the article having a micro uneven structure on a surface thereof as the second aspect of the invention.

One kind of the bifunctional monomer (B) may be used alone, or two or more kinds thereof may be used in combination.

A proportion of the bifunctional monomer (B) in the polymerizable component (X) is 20-60 mass %, and preferably 35-45 mass %. If the proportion of the bifunctional monomer (B) is 20 mass % or more, the adhesion to the TAC substrate is maintained. On the other hand, if the proportion of the bifunctional monomer (B) is 60 mass % or less, the shape of the convex part in the micro uneven structure may be well retained, whitening of the cured product due to bonding (unification) of adjacent convex parts is suppressed, and the optical properties are good.

Moreover, in the case where the proportion of the bifunctional monomer (B) is excessive, there may be cases where the optical properties cannot be maintained during a heat test or a high temperature and humidity test.

(Monomer (C3))

The monomer (C3) is a compound having 1 or more acrylamide groups in a molecule.

By combination with the above bifunctional monomer (B), the monomer (C3) contributes to improvement in the adhesion to the TAC substrate and viscosity reduction of the polymerizable component (X).

Examples of the monomer (C3) include: acrylamide, N-methylolacrylamide, N-(2-hydroxyethyl)acrylamide, N,N-dimethyl acrylamide, N,N-diethylacrylamide and so on.

One kind of the monomer (C3) may be used alone, or two or more kinds thereof may be used in combination.

A proportion of the monomer (C3) in the polymerizable component (X) is 5-30 mass %, and preferably 10-25 mass %. If the proportion of the monomer (C3) is 5 mass % or more, the adhesion to the TAC substrate is good. On the other hand, if the proportion of the monomer (C3) is 30 mass % or less, the rigidity of the convex part in the micro uneven structure is maintained, and the optical properties are good.

Moreover, in the case where the proportion of the monomer (C3) is excessive, there may be cases where the optical properties cannot be maintained during a heat test or a high temperature and humidity test.

(Monomer (D))

The monomer (D) is a compound having 1 or more free radical polymerizable functional groups in a molecule, and having a silicone skeleton in a molecule.

By combination with the bifunctional monomer (B) and the monomer (C3), the monomer (D) provides the adhesion of the cured product of the active energy ray curable resin composition to the TAC substrate, and the releasability from the mold having a micro uneven structure.

While the monomer (C3) improves the adhesion of the cured product of the active energy ray curable resin composition to the TAC substrate as mentioned above, the monomer (C3) causes deterioration in the releasability of the cured product of the active energy ray curable resin composition from the mold having a micro uneven structure. Accordingly, by making the active energy ray curable resin composition contain the monomer (D), the releasability from the mold may be made good while the adhesion to the TAC substrate is maintained.

Moreover, by combination of the bifunctional monomer (B) and the monomer (C3), sufficient adhesion may be obtained.

There is no particular limitation on the monomer (D) as long as it has 1 or more free radical polymerizable functional groups and a silicone skeleton in a molecule. Examples thereof include the monomer (D) exemplified in the description of the active energy ray curable resin composition used in the article having a micro uneven structure on a surface thereof as the third aspect of the invention.

In addition, commercial products may be used as the monomer (D). Examples thereof include the commercial products of the monomer (D) exemplified previously.

One kind of the monomer (D) may be used alone, or two or more kinds thereof may be used in combination.

A proportion of the monomer (D) in the polymerizable component (X) is 0.01-10 mass %, and preferably 0.1-5 mass %. If the proportion of the monomer (D) is 0.01 mass % or more, the releasability of the article having a micro uneven structure on a surface thereof from the mold is good. On the other hand, if the proportion of the monomer (D) is 10 mass % or less, the adhesion between the TAC substrate and the cured product is good, and the active energy ray curable resin composition is not cloudy.

(Other Polymerizable Components)

Within a scope of not damaging the effects of the invention, the polymerizable component (X) may contain other polymerizable components in addition to the polyfunctional monomer (A), the bifunctional monomer (B), the monomer (C3) and the monomer (D). Examples of other polymerizable components include: bi- or higher functional monomers other than the polyfunctional monomer (A) and the bifunctional monomer (B), oligomers or polymers having a free radical polymerizable functional group, and so on.

A proportion of the other polymerizable components in the polymerizable component (X) is preferably 30 mass % or less, more preferably 20 mass % or less, and especially preferably 10 mass % or less. That is, a total amount of the polyfunctional monomer (A), the bifunctional monomer (B), the monomer (C3) and the monomer (D) in the polymerizable component (X) is preferably 70 mass % or more.

(Photoinitiator (E))

The so-called photoinitiator (E) refers to a compound that is cleaved by irradiation with the active energy ray to generate a radical that initiates a polymerization reaction. In terms of equipment cost or productivity, the active energy ray is preferably ultraviolet ray.

Examples of the photoinitiator (E) that generates a radical by irradiation with ultraviolet ray, namely, examples of the photoinitiator include the photoinitiator (E) exemplified in the description of the active energy ray curable resin composition used in the article having a micro uneven structure on a surface thereof as the second aspect of the invention.

One kind of the photoinitiator (E) may be used alone, or two or more kinds thereof may be used in combination. In the case of combination, it is preferable that two or more kinds having different absorption wavelengths are used in combination.

In addition, depending on requirements, thermal polymerization initiators such as persulfate (potassium persulfate, ammonium persulfate and so on), peroxide (benzoyl peroxide and so on), azo initiators and so on may be used in combination.

Relative to 100 mass parts of the polymerizable component (X), the proportion of the photoinitiator (E) is preferably 0.01-10 mass parts, more preferably 0.1-5 mass parts, and further preferably 0.2-3 mass parts. If the proportion of the photoinitiator (E) is 0.01 mass part or more, the active energy ray curable resin composition is sufficiently cured, and the mechanical properties of the article having a micro uneven structure on a surface thereof are good. If the proportion of the photoinitiator (E) is 10 mass parts or less, the decrease in the elastic modulus of the cured product due to functioning of the non-reacted photoinitiator (E) remaining in the cured product as a plasticizer is prevented, and the scratch resistance is made good. In addition, coloring may also be prevented.

(Internal Mold Release Agent (F))

The internal mold release agent (F) is a component required for maintaining good mold releasability when continuously manufacturing the article in the fourth aspect of the invention. It contains a (poly)oxyalkylene alkyl phosphate compound and is adhered to the surface of the mold, and has an effect of increasing the continuous transfer property by exhibiting the mold releasability on the interface with the active energy ray curable resin composition and the cured product thereof. Particularly in the case of using the later-described mold of anodized alumina, the (poly)oxyalkylene alkyl phosphate compound interacts with alumina so that the internal mold release agent (F) is easily adhered to the surface of the mold.

In terms of excellent mold releasability, the (poly)oxyalkylene alkyl phosphate compound is preferably a compound represented by the above formula (f1).

Examples of commercial products of the (poly)oxyalkylene alkyl phosphate compound include the commercial products of the (poly)oxyalkylene alkyl phosphate compound exemplified in the description of the active energy ray curable resin composition used in the article having a micro uneven structure on a surface thereof as the second aspect of the invention.

One kind of the internal mold release agent (F) may be used alone, or two or more kinds thereof may be used in combination.

Relative to 100 mass parts of the polymerizable component (X), the proportion of the internal mold release agent (F) is preferably 0.01-2.0 mass parts, and preferably 0.05-0.2 mass part. If the proportion of the internal mold release agent (F) is 0.01 mass part or more, the releasability of the article having a micro uneven structure on a surface thereof from the mold is good. On the other hand, if the proportion of the internal mold release agent (F) is 2.0 mass % or less, the adhesion between the cured product of the active energy ray curable resin composition and the TAC substrate is good, the hardness of the cured product is proper, and the micro uneven structure may be sufficiently retained.

(Ultraviolet Absorber and/or Antioxidant (G))

The above active energy ray curable resin composition may further contain an ultraviolet absorber and/or an antioxidant (G), and so on.

Examples of the ultraviolet absorber and the antioxidant include the ultraviolet absorber and the antioxidant (G) exemplified in the description of the active energy ray curable resin composition used in the article having a micro uneven structure on a surface thereof as the first aspect of the invention.

One kind of the ultraviolet absorber and the antioxidant (G) may be used alone, or two or more kinds thereof may be used in combination.

Relative to 100 mass parts of the polymerizable component (X), the proportion of a total amount of the ultraviolet absorber and/or the antioxidant (G) is preferably 0.01-5 mass parts.

(Other Components)

Depending on requirements, the above active energy ray curable resin composition may also contain well-known additives such as plasticizer, antistatic agent, light stabilizer, flame retardant, flame retardant assistant, polymerization inhibitor, filler, silane coupling agent, colorant, reinforcing agent, inorganic filler, impact modifier and so on.

In addition, depending on requirements, the above active energy ray curable resin composition may also contain oligomers or polymers having no free radical polymerizable functional group, a minor amount (specifically, 5.0 mass % or less in 100 mass % of the active energy ray curable resin composition) of organic solvent and so on.

The above-described article having a micro uneven structure on a surface thereof as the fourth aspect of the invention is an article in which a micro uneven structure is formed on a TAC substrate, wherein the micro uneven structure includes a cured product of an active energy ray curable resin composition, wherein the active energy ray curable resin composition contains 30-60 mass % of the above polyfunctional monomer (A), 20-60 mass % of the above bifunctional monomer (B), 5-30 mass % of the above monomer (C3), 0.01-10 mass % of the above monomer (D), and the internal mold release agent (F) containing a (poly)oxyalkylene alkyl phosphate compound. The cured product of the active energy ray curable resin composition is provided with both the adhesion to the TAC substrate and the releasability from the mold for transferring a micro uneven structure.

Therefore, in regard to the article having a micro uneven structure on a surface thereof as the fourth aspect of the invention, the TAC substrate is sufficiently adhered with the cured product of the active energy ray curable resin composition having a micro uneven structure, and good releasability from the mold are provided. In addition, after various durability tests, the micro uneven structure may still be well retained.

In addition, according to the fourth aspect of the invention, even if no primer layer is disposed on the TAC substrate, an article in which the TAC substrate is sufficiently adhered with the cured product may be manufactured easily and inexpensively.

<Manufacturing Method for an Article having a Micro Uneven Structure on a Surface Thereof>

Although there is no particular limitation on a manufacturing method for the article having a micro uneven structure on a surface thereof, a method as follows is preferable for forming the micro uneven structure: the above active energy ray curable resin composition is caused to contact a mold having an inversion structure of a micro uneven structure on a surface thereof, and is cured.

Here, a manufacturing device used in manufacturing the article having a micro uneven structure on a surface thereof and an example of the mold are specifically described.

(Mold)

The mold has an inversion structure of a micro uneven structure on a surface thereof.

Examples of materials of the mold include: metal (including those having an oxide film formed on a surface thereof), quartz, glass, resin, ceramics and so on.

Example of a shape of the mold include: a roll shape, a circular pipe shape, a plate shape, a sheet shape and so on.

Examples of a manufacturing method for the mold include the following method (I-1) and method (I-2). In terms of realizing large size and easy manufacturing, the method (I-1) is especially preferable.

(I-1) a method of foaming anodized alumina having a plurality of pores (concave parts) on a surface of an aluminum substrate;

(I-2) a method of forming an inversion structure of a micro uneven structure on a surface of a mold substrate by an electron beam lithography method, a laser light interference method and so on.

As the method (I-1), a method including the following steps (a) to (f) is preferable.

(a) a step of anodizing an aluminum substrate in an electrolyte at a constant voltage to form an oxide film on a surface of the aluminum substrate;

(b) a step of removing a portion or all of the oxide film to foam a pore originating point of anodization on the surface of the aluminum substrate;

(c) after step (b), a step of re-anodizing the aluminum substrate in the electrolyte to form an oxide film having pores at the pore originating point;

(d) after step (c), a step of expanding a diameter of the pore;

(e) after step (d), a step of re-anodization in the electrolyte;

(f) a step of repeating steps (d) and (e) to obtain a mold, wherein the mold is obtained by forming anodized alumina having a plurality of pores on the surface of the aluminum substrate.

Step (a):

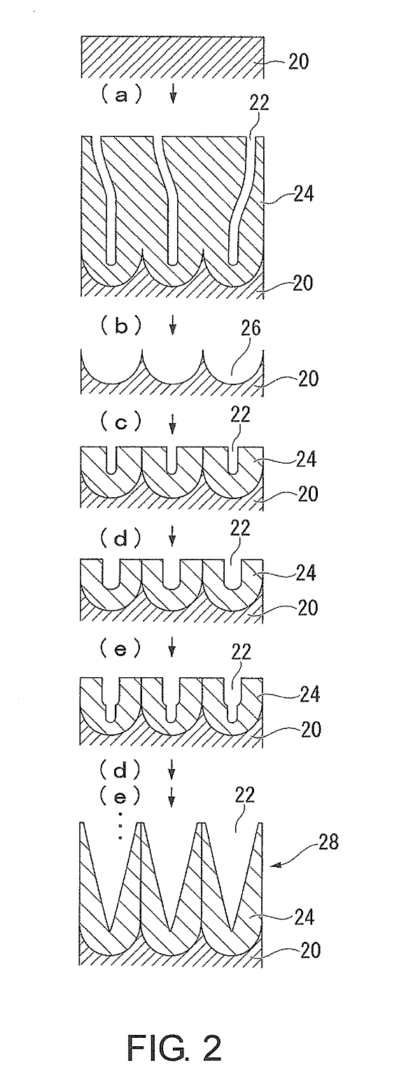

As shown in FIG. 2, when an aluminum substrate 20 is anodized, an oxide film 24 having pores 22 is formed.

Example of a shape of the aluminum substrate include a roll shape, a circular pipe shape, a plate shape, a sheet shape and so on.

In regard to the aluminum substrate, since oil used for processing it into a predetermined shape is adhered thereto, the aluminum substrate is preferably subjected to a degreasing treatment in advance. In addition, in regard to the aluminum substrate, in order to make its surface condition smooth, it is preferably subjected to an electropolishing treatment (etching treatment).

A purity of the aluminum is preferably 99% or more, more preferably 99.5% or more, and especially preferably 99.8% or more. If the purity of the aluminum is low, sometimes when the aluminum is anodized, a concavo-convex structure may be formed to have a size that allows visible light to be scattered due to segregation of impurities, or regularity of the pores obtained by anodization may decrease.

Examples of the electrolyte include sulfuric acid, oxalic acid, phosphoric acid and so on.

In the case where the oxalic acid is used as the electrolyte:

A concentration of the oxalic acid is preferably 0.7 M or less. When the concentration of the oxalic acid exceeds 0.7 M, sometimes a current value may become excessively high to cause a surface of the oxide film to become rough.

When a formation voltage is 30 V to 60 V, anodized alumina having pores with high regularity of a cycle of 100 nm may be obtained. The regularity has a tendency to decrease no matter the formation voltage is higher or lower than the range.

A temperature of the electrolyte is preferably 60° C. or lower, and more preferably 45° C. or lower. When the temperature of the electrolyte exceeds 60° C., a phenomenon, so-called “burning”, sometimes occurs, such that the pores are damaged or the regularity of the pores is broken due to melting of the surface.

In the case where the sulfuric acid is used as the electrolyte:

A concentration of the sulfuric acid is preferably 0.7 M or less. When the concentration of the sulfuric acid exceeds 0.7 M, sometimes the current value may become excessively high to make it impossible to maintain the constant voltage.

When the formation voltage is 25 V to 30 V, anodized alumina having pores with high regularity of a cycle of 63 nm may be obtained. The regularity has a tendency to decrease no matter the formation voltage is higher or lower than the range.

The temperature of the electrolyte is preferably 30° C. or lower, and more preferably 20° C. or lower. When the temperature of the electrolyte exceeds 30° C., the phenomenon, so-called “burning”, occurs, such that the pores are damaged or the regularity of the pores is broken due to melting of the surface.

Step (b):

As shown in FIG. 2, a portion or all of the oxide film 24 is temporarily removed to form a pore originating point 26 of anodization, thereby increasing the regularity of the pores. Even in a state where not all of the oxide film 24 is removed but a portion thereof remains, as long as a portion in which the regularity has been sufficiently increased remains in the oxide film 24, a purpose of removing the oxide film may be achieved.

Examples of a method of removing the oxide film include a method of removing the oxide film by dissolving it in a solution that does not dissolve aluminum but selectivity dissolves the oxide film. Examples of such solution include a mixture of chromic acid and phosphoric acid and so on.

Step (c):

As shown in FIG. 2, when the aluminum substrate 20 having the oxide film removed is re-anodized, the oxide film 24 having cylindrical pores 22 is formed.

The anodization may be performed under the same conditions as in step (a). The more the time for anodization is extended, the deeper the pore may be acquired. Nonetheless, within a scope of not losing the effects of step (b), the voltage of anodization, or type or temperature and so on of the electrolyte in step (c) may be properly adjusted.

Step (d):

As shown in FIG. 2, a treatment (hereinafter referred to as pore diameter expanding treatment) is performed to expand the diameter of the pores 22. The pore diameter expanding treatment is a treatment of expanding the diameter of the pores obtained by anodization by immersion in the solution that dissolves the oxide film. Examples of such solution include a roughly 5 mass % aqueous solution of phosphoric acid.

The more the time of the pore diameter expanding treatment is extended, the larger the pore diameter becomes.

Step (e):

As shown in FIG. 2, when anodization is performed again, the cylindrical pores 22 having a small diameter are further formed by extending downward from bottoms of the cylindrical pores 22.

The anodization may be performed under the same conditions as in step (a). The more the time for anodization is extended, the deeper the pore may be acquired.

Step (f):

As shown in FIG. 2, when the pore diameter expanding treatment in step (d) and the anodization in step (e) are repeated, the oxide film 24 is formed having the pores 22 in a shape in which the diameter continuously decreases from an opening toward the depth direction, thus obtaining a mold 28 having anodized alumina (porous oxide film of aluminum: alumite) on the surface of the aluminum substrate 20. The process is preferably ended with step (d).

A number of times of repetition is preferably 3 times or more, and more preferably 5 times or more. If the number of times of repetition is twice or fewer, since the diameter of the pores decreases discontinuously, an effect of reducing reflectivity of the moth-eye structure formed by anodized alumina having such pores is insufficient.

Examples of a shape of the pores 22 include a substantially conical shape, a pyramid shape, a cylindrical shape and so on. Shapes in which a cross-sectional area of the pore in a direction orthogonal to the depth direction decreases continuously in the depth direction from an uppermost surface, such as conical shape, pyramid shape and so on, are preferable.

An average interval between the pores 22 is preferably less than or equal to the visible light wavelength, i.e. 400 nm or less. The average interval between the pores 22 is preferably 20 nm or more.

The average interval between the pores 22 is obtained by measuring the spacing between adjacent pores 22 (distance from the center of the pore 22 to the center of the adjacent pore 22) at 50 locations through electron microscope observation, and then calculating an average of measured values.

A depth of the pores 22 is preferably 80 nm to 500 nm, more preferably 120 nm to 400 nm, and especially preferably 150 nm to 300 nm. In the case where the average interval between the pores 22 is around 100 nm, the situation is the same.

The depth of the pores 22 is a value obtained by measuring a distance between a lowermost portion of the pore 22 and an uppermost portion of a convex part existing between the pores 22 by observation with an electron microscope at a magnification of 30,000 times.

An aspect ratio of the pores 22 (the height of the pore/the average interval between the pores) is preferably 0.8 to 5, more preferably 1.2 to 4, and especially preferably 1.5 to 3.

A surface of a side of the mold on which a micro uneven structure is formed may be treated with a mold release agent.

Examples of the mold release agent include silicone resin, fluororesin, fluorine compounds, phosphate and so on. Fluorine compounds having a hydrolyzable silyl group or phosphate is especially preferable.

Examples of commercial products of the fluorine compound having a hydrolyzable silyl group include: “fluoroalkylsilane” and “KBM-7803” manufactured by Shin-Etsu Chemical Co., Ltd., “MRAF” manufactured by Asahi Glass Co., Ltd., “Optool HD1100” and “Optool HD2100 series” manufactured by HARVES Co., Ltd., “Optool AES4” and “Optool AES6” manufactured by Daikin Industries, Ltd., “Novec EGC-1720” manufactured by Sumitomo 3M Limited, “FS-2050” series manufactured by Fluoro Technology, and so on.

The phosphate is preferably a (poly)oxyalkylene alkyl phosphate compound. Examples of commercial products include “JP-506H” manufactured by Johoku Chemical Co., Ltd., “MoldWiz INT-1856” manufactured by Axel Plastics Research Laboratories, Inc., “TDP-10,” “TDP-8,” “TDP-6,” “TDP-2,” “DDP-10,” “DDP-8,” “DDP-6,” “DDP-4,” “DDP-2,” “TLP-4,” “TCP-5” and “DLP-10” manufactured by Nikko Chemicals Co., Ltd., and so on.

One kind of the mold release agent may be used alone, or two or more kinds thereof may be used in combination.

(Manufacturing Device)

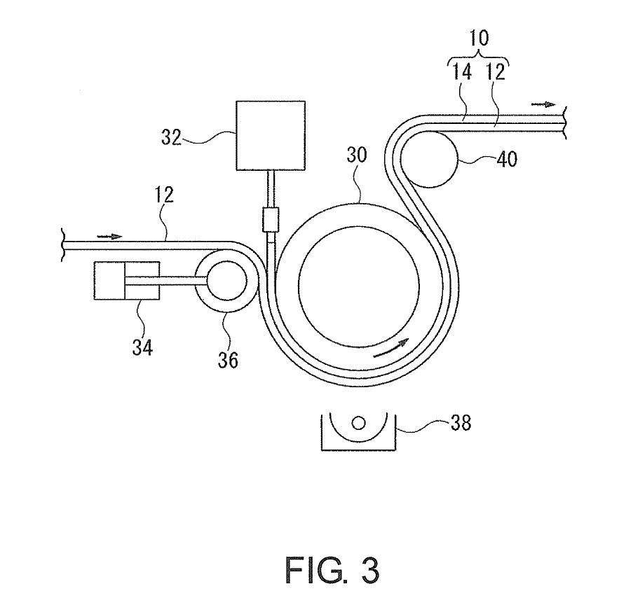

The article having a micro uneven structure on a surface thereof is manufactured in the following way by using, for example, a manufacturing device as shown in FIG. 3.

The above active energy ray curable resin composition is supplied from a tank 32 to between a roll-shaped mold 30 having an inversion structure of a micro uneven structure (illustration omitted) on a surface thereof and a TAC substrate 12 as a belt-shaped film moving along the surface of the roll-shaped mold 30.

The TAC substrate 12 and the active energy ray curable resin composition are nipped between the roll-shaped mold 30 and a nip roll 36 with nip pressure adjusted by a pneumatic cylinder 34 so that the active energy ray curable resin composition is filled into the concave parts in the micro uneven structure of the roll-shaped mold 30 while being uniformly dispersed between the TAC substrate 12 and the roll-shaped mold 30.

The TAC substrate 12 and the active energy ray curable resin composition are nipped between the roll-shaped mold 30 and a nip roll 36 with nip pressure adjusted by a pneumatic cylinder 34 so that the active energy ray curable resin composition is filled into the concave parts in the micro uneven structure of the roll-shaped mold 30 while being uniformly dispersed between the TAC substrate 12 and the roll-shaped mold 30.

An active energy ray-irradiation device 38 is preferably a high-pressure mercury lamp, a metal-halide lamp or the like. In this case, an amount of photoirradiation energy is preferably 100 mJ/cm² to 10000 mJ/cm².

<Use>

Application development of the article having a micro uneven structure on a surface thereof is expected in which it is used as an optical article such as antireflective article (antireflective membrane, antireflective film and so on), light guide, relief hologram, lens, polarization separating element and so on, or as a cell culture sheet, and it is particularly suitable for the use as an antireflective article.

Examples of antireflective articles include antireflective film, antireflective membrane, antireflective sheet and so on that are disposed on a surface of a video display device (liquid-crystal display device, plasma display panel, electroluminescence display, cathode tube display device and so on), lens, a show window, glasses and so on.

For example, in the case of use in a video display device, one or more of the article having a micro uneven structure on a surface thereof as the fifth aspect of the invention used as an antireflective article are disposed at a front of a screen (video display surface) of a video display device main body. At this moment, an antireflective film may be directly adhered to the screen as the antireflective article, or may be directly formed on a surface of a member that composes the screen as the antireflective article, or may be formed on a front panel as the antireflective article.

In addition, since the article having a micro uneven structure on a surface thereof includes the TAC substrate, even if it is adhered to a polarizing plate having a TAC film as a protective film, difference in refractive index is unlikely to occur, and the optical properties may be well maintained. Moreover, the article having a micro uneven structure on a surface thereof may also be used as replacement for the protective film of the polarizing plate. In addition, it is also suitable for cases where a front panel or a touch panel or the like is disposed on a liquid-crystal display, to a portion of which the article having a micro uneven structure on a surface thereof is adhered.

### Embodiments

In the following, the invention is described in further detail with reference to embodiments.

Various measurement and evaluation methods, the manufacturing method of the mold, and components used in the embodiments are as follows.

<Measurement and Evaluation>

(Measurement of Pores of Anodized Alumina)

A portion of anodized alumina was removed, and on a cross section, platinum was evaporated for 1 minute. The cross section was observed under a condition of an acceleration voltage of 3.00 kV using a field emission scanning electron microscope (manufactured by JEOL Ltd., “JSM-7400F”), so as to measure spacing between pores and pore depths. The measurements were each performed at 50 locations, and an average value thereof was set as a measured value.

(Measurement of Concave and Convex of Article)

A longitudinal section of the article having a micro uneven structure on a surface thereof was subjected to a Pt evaporation for 10 minutes, followed by measurement of the spacing between adjacent convex parts and the height of the convex part by means of the same device and conditions as in the measurement of pores of anodized alumina. Specifically, the measurements were each performed at 10 locations, and an average value thereof was set as a measured value.

(Evaluation of Adhesion)

An evaluation of adhesion was performed through a cross-cut tape peeling test (ISO2409:1992 (JIS K 5600-5-6:1999)).

Specifically, a face on an opposite side of the face having the micro uneven structure in the article (film) having a micro uneven structure on a surface thereof was adhered to an acrylic plate by an adhesive. A cut of a grid pattern of 36 squares (6×6) with a spacing of 2 mm was made on the face having the micro uneven structure using a cutter knife, and an adhesive tape (manufactured by Nichiban Co., Ltd., “Cellotape (registered trademark)”) was adhered to the part of the grid pattern. After that, the adhesive tape was peeled off, and a detachment state of the cured product on the substrate (TAC film) was observed to be classified into any one of type 0 to 5 defined in ISO2409:1992 (JIS K 5600-5-6:1999).

In addition, separately, the face on the opposite side of the face having the micro uneven structure in the article (film) having a micro uneven structure on a surface thereof was adhered to an acrylic plate by an adhesive. A cut of a grid pattern of 100 squares (10×10) with a spacing of 2 mm was made on the face having the micro uneven structure using a cutter knife, and the adhesive tape (manufactured by Nichiban Co., Ltd., “Cellotape (registered trademark)”) was adhered to the part of the grid pattern. After that, the adhesive tape was peeled off, and the detachment state of the cured product on the substrate (TAC film) was observed. The adhesion was evaluated according to the following evaluation criteria.

∘: No square among the 100 squares was peeled off.

Δ: Peel-off of 1 square or more and 85 squares or fewer among the 100 squares occurred.

×: Peel-off of more than 85 squares among the 100 squares occurred.

(Evaluation of Mold Releasability)

A peel force from the mold was measured at a time point at which a number of times of transfer using the same mold was counted 1,000 times. Specifically, when the cured product of the active energy ray curable resin composition was released from the mold after curing, the peel force (peel strength) of peel-off at an angle of 90 degrees was measured using a Tensilon universal testing machine, and peeling property was evaluated according to the following evaluation criteria.

⊚: Peel strength was less than 15 N/m.

∘: Peel strength was 15 N/m or more and less than 30 N/m.

Δ: Peel strength was 30 N/m or more and less than 50 N/m.

×: Peel strength was 50 N/m or more.

(Evaluation of Optical Properties)

As an evaluation of optical properties, antireflection performance and transparency were evaluated in the following way. Moreover, the evaluation of optical properties was performed only in the case where a result of the evaluation of adhesion was “∘”.

### Antireflection Performance:

A surface of a side where no micro uneven structure is formed in the article having a micro uneven structure on a surface thereof was roughened using a sand paper, followed by coating with a delustering black spray. With the respect to the coated sample, relative reflectivity of a surface of the cured resin layer was measured at an incident angle of 5° in a wavelength range of 380 to 780 nm using a spectrophotometer (manufactured by Hitachi, Ltd., “U-4000”), and a weighted average reflectivity was calculated according to JIS R3106. If the weighted average reflectivity was 0.2% or less, it was determined that the micro uneven structure exhibits good antireflection performance, which was evaluated as “∘”. On the other hand, in the case where the weighted average reflectivity was more than 0.2%, it was determined that the antireflection performance is poor, which was evaluated as “×”.

Transparency:

Haze of the article having a micro uneven structure on a surface thereof was measured using a haze meter (manufactured by Nippon Denshoku Industries Co., Ltd., “NDH2000”). If the haze was less than 1.0%, it was determined that good transparency (light transmissive property) is exhibited, which was evaluated as “∘”. On the other hand, in the case where the haze was 1.0% or more, it was determined that the transparency is poor, which was evaluated as “×”.

<Manufacture of Mold>

An aluminum plate with a purity of 99.99% was subjected to fabric polishing, and electropolishing in a mixed solution of perchloric acid/ethanol (at a volume ratio of 1/4), thereby being made into a mirror surface.

### Step (a):

The aluminum plate was anodized in a 0.3 M oxalic acid aqueous solution for 30 minutes under conditions of a direct current 40 V and a temperature of 16° C.

### Step (b):

The aluminum plate having an oxide film formed thereon was immersed in a mixed aqueous solution of 6 mass % of phosphoric acid/1.8 mass % of chromic acid for 6 hours, thereby removing the oxide film.

### Step (c):

The aluminum plate was anodized in the 0.3 M oxalic acid aqueous solution for 30 seconds under the conditions of a direct current of 40 V and a temperature of 16° C.

### Step (d):

The aluminum plate having an oxide film formed thereon was immersed in 5 mass % of phosphoric acid having a temperature of 32° C. for 8 minutes to perform a pore diameter expanding treatment.

### Step (e):

The aluminum plate was anodized in the 0.3 M oxalic acid aqueous solution for 30 seconds under the conditions of a direct current of 40 V and a temperature of 16° C.

### Step (f):

The steps (d) and (e) were repeated 4 times in total with the step (d) as the last step, thereby obtaining a mold having anodized alumina formed on a surface thereof, wherein the anodized alumina has substantially conical shaped pores having an average interval of 100 nm and a depth of 180 nm.

The obtained mold was washed with deionized water, followed by removal of water from the surface using an air blower. The resultant was immersed for 10 minutes in a solution obtained by diluting Optool DSX (manufactured by Daikin Industries, Ltd.) with a diluent HD-ZV (manufactured by HARVES Co., Ltd.) in a manner in which solid content becomes 0.1 mass %, and was removed from the solution and air dried for 20 hours, thereby obtaining a mold treated with a mold release agent.

<Various Components>

<Polymerizable Component (X)>

Various monomers that compose the polymerizable component (X) used in the embodiments were as shown in the following Table 1.

TABLE 1

| | | | Number of | Molecular weight per |
|---|---|---|---|---|
| Monomer component | Abbreviation | Compound name | functional groups | (meth)acryloyl group |
| Polyfunctional monomer (A) | DPHA | dipentaerythritol penta(hexa)acrylate | 5~6 | 96 |
| Polyfunctional monomer (A) | PETA | pentaerythritol tri(tetra)acrylate | 3~4 | 99 |
| Bifunctional monomer (B) | PEGDA-2E | polyethylene glycol diacrylate (EO ≈ 2 mols) | 2 | — |
| Bifunctional monomer (B) | PEGDA-3E | polyethylene glycol diacrylate (EO ≈ 3 mols) | 2 | — |
| Bifunctional monomer (B) | PEGDA-4E | polyethylene glycol diacrylate (EO ≈ 4 mols) | 2 | — |
| Bifunctional monomer (B′) | PEGDA-7E | polyethylene glycol diacrylate (EO ≈ 6.8 mols) | 2 | — |
| Bifunctional monomer (B′) | PEGDA-9E | polyethylene glycol diacrylate (EO ≈ 9 mols) | 2 | — |
| Monomer (C2) | ACMO | acryloyl morpholine | 1 | — |
| Monomer (C1) | GBLA | γ-butyrolactone acrylate | 1 | — |
| Monomer (C1) | HEA | 2-hydroxyethyl acrylate | 1 | — |
| Monomers (C1), (C3) | DMAA | N,N-dimethylacrylamide | 1 | — |
| Monomers (C1), (C3) | DEAA | N,N-diethylacrylamide | 1 | — |
| Monomer (C1) | OXZA | oxazolidone-N-ethyl acrylate | 1 | — |
| Monomer (C1) | MA | methyl acrylate | 1 | — |
| Monomer (C1) | EA | ethyl acrylate | 1 | — |
| Monomer (C1′) | THFA | tetrahydrofurfuryl acrylate | 1 | — |
| Monomer (C1′) | IBXA | isobornyl acrylate | 1 | — |
| Monomers (C1′), (C3) | HEAA | hydroxyethyl acrylamide | 1 | — |
| Monomer (C1′) | CYA | cyclohexyl acrylate | 1 | — |
| Monomer (C1′) | HBA | 4-hydroxybutyl acrylate | 1 | — |
| Monomer (C1′) | CHDMMA | 1,4-cyclohexanedimethanol monoacrylate | 1 | — |
| Monomer (D) | BYK-UV3570 | acryloyl group-containing polyester-modified | — | — |
| | | polydimethylsiloxane (diluted with modified | | |
| | | propoxyl 2-neopentyl glycol diacrylate) | | |
| Monomer (D) | BYK-UV3500 | acryloyl group-containing polyether-modified | — | — |
| | | polydimethylsiloxane | | |
| Monomer (D) | X-22-1602 | acryloyl group-containing polyether-modified | — | — |
| | | polydimethylsiloxane | | |

In Table 1, “dipentaerythritol penta(hexa)acrylate” refers to a mixture of dipentaerythritol pentaacrylate and dipentaerythritol hexaacrylate, and “pentaerythritol tri(tetra)acrylate” refers to a mixture of pentaerythritol triacrylate and pentaerythritol tetraacrylate.

In addition, “EO” refers to oxyethylene group.

<Photoinitiator (E)>

The photoinitiator (E) used in the embodiments is as follows.

Irg.184: 1-hydroxy-cyclohexyl-phenyl-ketone (manufactured by BASF SE, “IRGACURE 184”);

Irg.819: bis(2,4,6-trimethylbenzoyl)-phenyl phosphine oxide (manufactured by BASF SE, “IRGACURE 819”).

<Internal Mold Release Agent (F)>

The internal mold release agent (F) used in the embodiments is as follows.

TDP-2: (poly)oxyethylene alkyl phosphate (manufactured by Nikko Chemicals Co., Ltd., “TDP-2”).

MT-1856: (poly)oxyethylene alkyl phosphate (manufactured by Axel Plastics Research Laboratories, Inc., “Moldwiz INT-1856”).

### EXAMPLE 1-1

20 mass parts of DPHA and 30 mass parts of PETA as the polyfunctional monomer (A), 35 mass parts of PEGDA-4E as the bifunctional monomer (B), and 15 mass parts of GBLA as the monomer (C1) were mixed together, 1 mass part of Irg.184 and 0.5 mass part of Irg.819 as the photoinitiator (E), and 0.1 mass part of TDP-2 as the internal mold release agent (F) were further added thereto and mixed therewith, thereby preparing the active energy ray curable resin composition.

A few drops of the active energy ray curable resin composition were dropped on the surface of the mold, and the resultant was covered while being expanded by a TAC film (manufactured by Fujifilm Corporation, “TD80ULM”) having a thickness of 80 μm, followed by irradiation from the film side using a high-pressure mercury lamp at energy of 1000 mJ/cm², thereby being cured.

The mold was released from the film to obtain the article (film) having a micro uneven structure on a surface thereof, wherein the average interval between the convex parts is 100 nm and the height thereof is 180 nm.

With respect to the obtained film, the evaluations of adhesion and optical properties were performed. In addition, the evaluation of mold releasability was also performed only in the case where the result of the evaluation of adhesion was “∘”. Results thereof are shown in Table 2.

### EXAMPLE 1-2 TO EXAMPLE 1-22

The active energy ray curable resin composition was prepared in the same manner as in Example 1-1 except that the composition of the active energy ray curable resin composition was changed to those shown in Table 2 and Table 3, thereby obtaining the article (film) having a micro uneven structure on a surface thereof. Results of the evaluations are shown in Table 2 and Table 3.

Moreover, Examples 1-1 to 1-11, 1-20 and 1-22 are equivalent to embodiments, while Examples 1-12 to 1-19 and 1-21 are equivalent to comparative examples.

TABLE 2

| Components of active energy ray | | | Example | | | | | | | | | | |
|---|---|---|---|---|---|---|---|---|---|---|---|---|---|
| curable resin composition (mass part) | | | 1-1 | 1-2 | 1-3 | 1-4 | 1-5 | 1-6 | 1-7 | 1-8 | 1-9 | 1-10 | 1-11 |
| Polymerizable | Polyfunctional | DPHA | 20 | 20 | 20 | 20 | 25 | 20 | 20 | 30 | 35 | 30 | 20 |
| component (X) | monomer (A) | PETA | 30 | 25 | 20 | 20 | 25 | 20 | 20 | 30 | 0 | 0 | 20 |
| | Bifunctional | PEHDA-2E | 0 | 0 | 0 | 0 | 0 | 0 | 0 | 0 | 0 | 0 | 50 |
| | monomer (B) | PEGDA-3E | 0 | 0 | 0 | 0 | 0 | 0 | 0 | 0 | 60 | 0 | 0 |
| | | PEGDA-4E | 35 | 35 | 40 | 35 | 40 | 35 | 35 | 30 | 0 | 40 | 0 |
| | Monomer (C1) | GBLA | 15 | 0 | 0 | 0 | 0 | 0 | 0 | 0 | 0 | 0 | 0 |
| | | HEA | 0 | 20 | 0 | 0 | 0 | 0 | 0 | 10 | 0 | 30 | 10 |
| | | DMAA | 0 | 0 | 20 | 0 | 0 | 0 | 0 | 0 | 5 | 0 | 0 |
| | | DEAA | 0 | 0 | 0 | 25 | 0 | 0 | 0 | 0 | 0 | 0 | 0 |
| | | OXZA | 0 | 0 | 0 | 0 | 10 | 0 | 0 | 0 | 0 | 0 | 0 |
| | | MA | 0 | 0 | 0 | 0 | 0 | 25 | 0 | 0 | 0 | 0 | 0 |
| | | EA | 0 | 0 | 0 | 0 | 0 | 0 | 25 | 0 | 0 | 0 | 0 |
| Photoinitiator (E) | | Irg. 184 | 1 | 1 | 1 | 1 | 1 | 1 | 1 | 1 | 1 | 1 | 1 |
| | | Irg. 819 | 0.5 | 0.5 | 0.5 | 0.5 | 0.5 | 0.5 | 0.5 | 0.5 | 0.5 | 0.5 | 0.5 |
| Internal mold release agent (F) | | TDP-2 | 0.1 | 0.1 | 0.1 | 0.1 | 0.1 | 0.1 | 0.1 | 0.1 | 0.1 | 0.1 | 0.1 |
| Results of Evaluation | Adhesion | Class | 0 | 0 | 0 | 0 | 0 | 0 | 0 | 0 | 0 | 0 | 0 |
| | | Evaluation | ◯ | ◯ | ◯ | ◯ | ◯ | ◯ | ◯ | ◯ | ◯ | ◯ | ◯ |

| | | | | | | | | | | | |
|---|---|---|---|---|---|---|---|---|---|---|---|
| Antireflection performance | ◯ | ◯ | ◯ | ◯ | ◯ | ◯ | ◯ | ◯ | ◯ | ◯ | ◯ |
| Transparency | ◯ | ◯ | ◯ | ◯ | ◯ | ◯ | ◯ | ◯ | ◯ | ◯ | ◯ |
| Mold releasability | ◯ | ◯ | ◯ | ◯ | ◯ | ◯ | ◯ | ◯ | ◯ | ◯ | ◯ |

TABLE 3

| Components of active energy ray | | | Example | | | | | | | | | | |
|---|---|---|---|---|---|---|---|---|---|---|---|---|---|
| curable resin composition (mass part) | | | 1-12 | 1-13 | 1-14 | 1-15 | 1-16 | 1-17 | 1-18 | 1-19 | 1-20 | 1-21 | 1-22 |
| Polymerizable | Polyfunctional | DPHA | 20 | 20 | 20 | 20 | 20 | 20 | 20 | 20 | 65 | 25 | 20 |
| component (X) | monomer (A) | PETA | 20 | 20 | 20 | 20 | 20 | 20 | 20 | 20 | 0 | 20 | 0 |
| | Bifunctional | PEGDA-3E | 0 | 0 | 0 | 0 | 0 | 0 | 0 | 0 | 30 | 0 | 0 |
| | monomer (B) | PEGDA-4E | 35 | 35 | 35 | 35 | 35 | 35 | 0 | 0 | 0 | 25 | 65 |
| | Bifunctional | PEGDA-7E | 0 | 0 | 0 | 0 | 0 | 0 | 35 | 0 | 0 | 0 | 0 |
| | monomer (B′) | PEGDA-9E | 0 | 0 | 0 | 0 | 0 | 0 | 0 | 35 | 0 | 0 | 0 |
| | Monomer (C1) | HEA | 0 | 0 | 0 | 0 | 0 | 0 | 0 | 25 | 0 | 30 | 0 |
| | | DMAA | 0 | 0 | 0 | 0 | 0 | 0 | 25 | 0 | 0 | 0 | 15 |
| | | DEAA | 0 | 0 | 0 | 0 | 0 | 0 | 0 | 0 | 5 | 0 | 0 |
| | Monomer (C1′) | THFA | 25 | 0 | 0 | 0 | 0 | 0 | 0 | 0 | 0 | 0 | 0 |
| | | IBXA | 0 | 25 | 0 | 0 | 0 | 0 | 0 | 0 | 0 | 0 | 0 |
| | | HEAA | 0 | 0 | 25 | 0 | 0 | 0 | 0 | 0 | 0 | 0 | 0 |
| | | CYA | 0 | 0 | 0 | 25 | 0 | 0 | 0 | 0 | 0 | 0 | 0 |
| | | HBA | 0 | 0 | 0 | 0 | 25 | 0 | 0 | 0 | 0 | 0 | 0 |
| | | CHDMMA | 0 | 0 | 0 | 0 | 0 | 25 | 0 | 0 | 0 | 0 | 0 |
| Photoinitiator (E) | | Irg. 184 | 1 | 1 | 1 | 1 | 1 | 1 | 1 | 1 | 1 | 1 | 1 |
| | | Irg. 819 | 0.5 | 0.5 | 0.5 | 0.5 | 0.5 | 0.5 | 0.5 | 0.5 | 0.5 | 0.5 | 0.5 |
| Internal mold release agent (F) | | TDP-2 | 0.1 | 0.1 | 0.1 | 0.1 | 0.1 | 0.1 | 0.1 | 0.1 | 0.1 | 0.1 | 0.1 |
| Results of Evaluation | Adhesion | Class | 5 | 5 | 5 | 5 | 5 | 5 | 5 | 5 | 0 | 5 | 0 |
| | | Evaluation | X | X | X | X | X | X | X | X | ◯ | X | ◯ |

| | | | | | | | | | | | |
|---|---|---|---|---|---|---|---|---|---|---|---|
| Antireflection performance | — | — | — | — | — | — | — | — | ◯ | — | ◯ |
| Transparency | — | — | — | — | — | — | — | — | X | — | X |
| Mold releasability | — | — | — | — | — | — | — | — | ◯ | — | ◯ |

As clear from the results in the Tables, in regard to the article having a micro uneven structure on a surface thereof obtained in Examples 1-1 to 1-11, the TAC film is sufficiently adhered with the cured product of the active energy ray curable resin composition, and the optical properties were excellent.

In regard to the article having a micro uneven structure on a surface thereof obtained in Examples 1-12 to 1-17, since a monomer (monomer (C1′)) other than the above specific monomer (C1) was used, the adhesion of the cured product to the TAC film was low.

In regard to the article having a micro uneven structure on a surface thereof obtained in Examples 1-18 and 1-19, since a bifunctional monomer (B′) having more than 4 oxyethylene groups was used, the adhesion of the cured product to the TAC film was low.

In regard to the article having a micro uneven structure on a surface thereof obtained in Example 1-20, since the proportion of the polyfunctional monomer (A) in the active energy ray curable resin composition was high, cracks occurred in the cured product of the active energy ray curable resin composition in the release from the mold. The optical properties were inferior to those of Examples 1-1 to 1-11.

In regard to the article having a micro uneven structure on a surface thereof obtained in Example 1-21, since the proportion of the bifunctional monomer (B) in the active energy ray curable resin composition was low, the adhesion of the cured product to the TAC film was low.

In regard to the article having a micro uneven structure on a surface thereof obtained in Example 1-22, since the proportion of the bifunctional monomer (B) in the active energy ray curable resin composition was high, whitening was confirmed by appearance. The optical properties were inferior to those of Examples 1-1 to 1-11. When the micro uneven structure of the obtained article was observed by means of an electron microscope, it was determined that the micro uneven structure is not retained, and adjacent convex parts are bonded (unified) with each other.

### EXAMPLE 2-1

20 mass parts of DPHA and 19 mass parts of PETA as the polyfunctional monomer (A), 35 mass parts of PEGDA-4E as the bifunctional monomer (B), 25 mass parts of ACMO as the monomer (C2), and 1 mass part of BYK-UV3570 (manufactured by BYK Japan KK) as the monomer (D) were mixed together, 1 mass part of Irg.184 and 0.5 mass part of Irg.819 as the photoinitiator (E), and 0.1 mass part of TDP-2 as the internal mold release agent (F) were further added thereto and mixed therewith, thereby preparing the active energy ray curable resin composition.

A few drops of the active energy ray curable resin composition were dropped on the surface of the mold, and the resultant was covered while being expanded by a TAC film (manufactured by Fujifilm Corporation, “TD80ULM”) having a thickness of 80 μm, followed by irradiation from the film side using a high-pressure mercury lamp at energy of 1000 mJ/cm², thereby being cured.

The mold was released from the film to obtain the article (film) having a micro uneven structure on a surface thereof, wherein the average interval between the convex parts is 100 nm and the height thereof is 180 nm.

With respect to the obtained film, the evaluations of adhesion and mold releasability were performed. Results thereof are shown in Table 4.

### EXAMPLE 2-2 TO EXAMPLE 2-13

The active energy ray curable resin composition was prepared in the same manner as in Example 2-1 except that the composition of the active energy ray curable resin composition was changed to those shown in Table 4 and Table 5, thereby obtaining the article (film) having a micro uneven structure on a surface thereof. Results of the evaluations are shown in Table 4 and Table 5.

Moreover, Examples 2-1 to 2-8 and 2-10 are equivalent to embodiments, while Examples 2-9 and 2-11 to 2-13 are equivalent to comparative examples.

TABLE 4

| Components of active energy ray | | | Example | | | | | | | |
|---|---|---|---|---|---|---|---|---|---|---|
| curable resin composition (mass part) | | | 2-1 | 2-2 | 2-3 | 2-4 | 2-5 | 2-6 | 2-7 | 2-8 |
| Polymerizable | Polyfunctional | DPHA | 20 | 20 | 20 | 20 | 20 | 25 | 20 | 20 |
| component (X) | monomer (A) | PETA | 19 | 19 | 19 | 19.99 | 10 | 24.9 | 19 | 19 |
| | Bifunctional | PEGDA-2E | 0 | 0 | 0 | 0 | 0 | 0 | 0 | 35 |
| | monomer (B) | PEGDA-3E | 0 | 0 | 0 | 0 | 0 | 0 | 35 | 0 |
| | | PEGDA-4E | 35 | 30 | 40 | 35 | 35 | 30 | 0 | 0 |
| | Monomer (C2) | ACMO | 25 | 30 | 20 | 25 | 25 | 20 | 25 | 25 |
| | Monomer (D) | BYK-UV3570 | 1 | 0 | 0 | 0 | 0 | 0.1 | 1 | 1 |
| | | BYK-UV3500 | 0 | 1 | 0 | 0 | 0 | 0 | 0 | 0 |
| | | X-22-1602 | 0 | 0 | 1 | 0.01 | 10 | 0 | 0 | 0 |
| Photoinitiator (E) | | Irg. 184 | 1 | 1 | 1 | 1 | 1 | 1 | 1 | 1 |
| | | Irg. 819 | 0.5 | 0.5 | 0.5 | 0.5 | 0.5 | 0.5 | 0.5 | 0.5 |
| Internal mold release agent (F) | | TDP-2 | 0.1 | 0.1 | 0.1 | 0.1 | 0.1 | 0.1 | 0.1 | 0.1 |
| Results of Evaluation | Adhesion | Class | 0 | 0 | 0 | 0 | 0 | 0 | 0 | 0 |
| | | Evaluation | ◯ | ◯ | ◯ | ◯ | ◯ | ◯ | ◯ | ◯ |

| | | | | | | | | |
|---|---|---|---|---|---|---|---|---|
| Mold releasability | ⊚ | ⊚ | ⊚ | ⊚ | ⊚ | ⊚ | ⊚ | ⊚ |

TABLE 5

| Components of active energy ray | | | Example | | | | |
|---|---|---|---|---|---|---|---|
| curable resin composition (mass part) | | | 2-9 | 2-10 | 2-11 | 2-12 | 2-13 |
| Polymerizable | Polyfunctional | DPHA | 20 | 20 | 30 | 20 | 20 |
| component (X) | monomer (A) | PETA | 20 | 20 | 25 | 20 | 20 |
| | Bifunctional | PEGDA-4E | 45 | 35 | 24 | 0 | 0 |
| | monomer (B) | | | | | | |
| | Bifunctional | PEGDA-7E | 0 | 0 | 0 | 45 | 0 |
| | monomer (B′) | PEGDA-9E | 0 | 0 | 0 | 0 | 45 |
| | Monomer (C2) | ACMO | 15 | 25 | 20 | 15 | 15 |
| | Monomer (D) | BYK-UV3570 | 0 | 0 | 1 | 0 | 0 |
| Photoinitiator (E) | | Irg. 184 | 1 | 1 | 1 | 1 | 1 |
| | | Irg. 819 | 0.5 | 0.5 | 0.5 | 0.5 | 0.5 |
| Internal mold release agent (F) | | TDP-2 | 0.1 | 0.1 | 0 | 0.1 | 0.1 |
| Results of Evaluation | Adhesion | Class | 4 | 0 | 4 | 5 | 5 |
| | | Evaluation | Δ | ◯ | Δ | X | X |

| | | | | | |
|---|---|---|---|---|---|
| Mold releasability | Δ | Δ | X | Δ | Δ |

As clear from the results in the Tables, in regard to the article having a micro uneven structure on a surface thereof obtained in Examples 2-1 to 2-8, the TAC film was sufficiently adhered with the cured product of the active energy ray curable resin composition. In addition, the releasability from the mold was good.

In regard to the article having a micro uneven structure on a surface thereof obtained in Example 2-9, since the proportion of the monomer (C2) in the active energy ray curable resin composition was low, the adhesion of the cured product to the TAC film was lower than that of Examples 2-1 to 2-8. In addition, since the monomer (D) was not contained, the releasability from the mold was inferior to that of Examples 2-1 to 2-8.

In regard to the article having a micro uneven structure on a surface thereof obtained in Example 2-10, since the active energy ray curable resin composition did not contain the monomer (D), the releasability from the mold was inferior to that of Examples 2-1 to 2-8.

In regard to the article having a micro uneven structure on a surface thereof obtained in Example 2-11, since the proportion of the bifunctional monomer (B) in the active energy ray curable resin composition was low, the adhesion of the cured product to the TAC film was lower than that of Examples 2-1 to 2-8. In addition, since the internal mold release agent (F) was not contained, the releasability from the mold was poor.

In regard to the article having a micro uneven structure on a surface thereof obtained in Examples 2-12 and 2-13, since the bifunctional monomer (B′) having more than 4 oxyethylene groups was used, and the proportion of the monomer (C2) in the active energy ray curable resin composition was low, the adhesion of the cured product to the TAC film was low. In addition, since the monomer (D) was not contained, the releasability from the mold was poor.

### EXAMPLE 3-1

20 mass parts of DPHA and 19 mass parts of PETA as the polyfunctional monomer (A), 40 mass parts of PEGDA-4E as the bifunctional monomer (B), 20 mass parts of DMAA as the monomer (C3), and 1 mass part of BYK-UV3570 (manufactured by BYK Japan KK) as the monomer (D) were mixed together, 1 mass part of Irg.184 and 0.5 mass part of Irg.819 as the photoinitiator (E), and 0.1 mass part of TDP-2 as the internal mold release agent (F) were further added thereto and mixed therewith, thereby preparing the active energy ray curable resin composition.

A few drops of the active energy ray curable resin composition were dropped on the surface of the mold, and the resultant was covered while being expanded by a TAC film (manufactured by Fujifilm Corporation, “TD80ULM”) having a thickness of 80 μm, followed by irradiation from the film side using a high-pressure mercury lamp at energy of 1000 mJ/cm², thereby being cured.

The mold was released from the film to obtain the article (film) having a micro uneven structure on a surface thereof, wherein the average interval between the convex parts is 100 nm and the height thereof is 180 nm.

With respect to the obtained film, the evaluations of adhesion and mold releasability were performed. Results thereof are shown in Table 6.

### EXAMPLE 3-2 TO EXAMPLE 3-11

The active energy ray curable resin composition was prepared in the same manner as in Example 3-1 except that the composition of the active energy ray curable resin composition was changed to that shown in Table 6, thereby obtaining the article (film) having a micro uneven structure on a surface thereof. Results of the evaluations are shown in Table 6.

Moreover, Examples 3-1 to 3-11 are equivalent to embodiments.

TABLE 6

| Components of active energy ray | | | Example | | | | | | | | | | |
|---|---|---|---|---|---|---|---|---|---|---|---|---|---|
| curable resin composition (mass part) | | | 3-1 | 3-2 | 3-3 | 3-4 | 3-5 | 3-6 | 3-7 | 3-8 | 3-9 | 3-10 | 3-11 |
| Polymerizable | Polyfunctional | DPHA | 20 | 20 | 20 | 20 | 25 | 20 | 20 | 25 | 20 | 20 | 20 |
| component (X) | monomer (A) | PETA | 19 | 19.5 | 22 | 24 | 24 | 24 | 19 | 24 | 20 | 20 | 20 |
| | Bifunctional | PEGDA-4E | 40 | 40 | 30 | 45 | 30 | 30 | 40 | 30 | 35 | 40 | 35 |
| | monomer (B) | | | | | | | | | | | | |
| | Monomer (C3) | DMAA | 20 | 20 | 25 | 10 | 20 | 25 | 20 | 20 | 25 | 20 | 25 |
| | Monomer (D) | BYK-UV3570 | 1 | 0.5 | 3 | 1 | 1 | 0 | 1 | 1 | 0 | 0 | 0 |
| | | BYK-UV3500 | 0 | 0 | 0 | 0 | 0 | 1 | 0 | 0 | 0 | 0 | 0 |
| Photoinitiator (E) | | Irg. 184 | 1 | 1 | 1 | 1 | 1 | 1 | 1 | 1 | 1 | 1 | 1 |
| | | Irg. 819 | 0.5 | 0.5 | 0.5 | 0.5 | 0.5 | 0.5 | 0.5 | 0.5 | 0.5 | 0.5 | 0.5 |
| Internal mold release agent (F) | | TDP-2 | 0.1 | 0.1 | 0.1 | 0.1 | 0.1 | 0 | 0 | 0 | 0.1 | 0 | 0 |
| | | INT-1856 | 0 | 0 | 0 | 0 | 0 | 0.1 | 0.1 | 0.1 | 0 | 0.1 | 0 |
| Results of Evaluation | Adhesion | Class | 0 | 0 | 0 | 0 | 0 | 0 | 0 | 0 | 0 | 0 | 0 |
| | | Evaluation | ◯ | ◯ | ◯ | ◯ | ◯ | ◯ | ◯ | ◯ | ◯ | ◯ | ◯ |

| | | | | | | | | | | | |
|---|---|---|---|---|---|---|---|---|---|---|---|
| Mold releasability | ⊚ | ⊚ | ⊚ | ⊚ | ⊚ | ⊚ | ⊚ | ⊚ | ◯ | ◯ | X |

As clear from the results in the Tables, in regard to the article having a micro uneven structure on a surface thereof obtained in Examples 3-1 to 3-8, the TAC film was sufficiently adhered with the cured product of the active energy ray curable resin composition. In addition, the releasability from the mold was good.

In regard to the article having a micro uneven structure on a surface thereof obtained in Examples 3-9 to 3-11, since the active energy ray curable resin composition did not contain the monomer (D), the releasability from the mold was poor. Particularly in Example 3-11 in which the active energy ray curable resin composition did not contain the internal mold release agent (F), the mold releasability was even inferior to that of Example 3-9 and 3-10.

### INDUSTRIAL USABILITY

According to the article having a micro uneven structure on a surface thereof of the invention, since the micro uneven composed of the cured product of the active energy ray curable resin composition is directly formed on the TAC substrate, it is possible to manufacture the article easily and inexpensively. The article has excellent optical properties and is applicable to various displays such as television, cell phone, portable game console and so on, and thus is extremely industrially useful.

### DESCRIPTION OF THE REFERENCE NUMBERS

10: Article having a micro uneven structure on a surface thereof

12: TAC substrate

14: Cured resin layer

22: Pore (inversion structure of a micro uneven structure)

28: Mold

30: Roll-shaped mold

1. An article having a micro uneven structure on a surface thereof, wherein the article is obtained by forming a micro uneven structure composed of a cured product of a solvent-free active energy ray curable resin composition on a substrate containing triacetylcellulose; and
wherein an average interval between two adjacent convex parts in the micro uneven structure is less than or equal to a visible light wavelength, and
adhesion between the substrate containing triacetylcellulose and a layer composed of the cured product of the active energy ray curable resin composition is classified into any one of type 0 to 2 according to a crosscut method defined in ISO2409:1992 (JIS K 5600-5-6:1999).

2. The article having a micro uneven structure on a surface thereof according to claim 1, wherein the active energy ray curable resin composition contains a polymerizable component (X) and a photoinitiator (E);
wherein the polymerizable component (X) contains 30-60 mass % of a polyfunctional monomer (A), 30-60 mass % of a bifunctional monomer (B) and 5-30 mass % of a monomer (C1), wherein the polyfunctional monomer (A) has 3 or more free radical polymerizable functional groups in a molecule and each functional group thereof has a molecular weight of 150 or less, the bifunctional monomer (B) has 2 free radical polymerizable functional groups in a molecule and 4 or fewer oxyalkylene groups in the molecule, and the monomer (C1) is at least one selected from a group consisting of γ-butyrolactone acrylate, 2-hydroxyethyl acrylate, N,N-dimethylacrylamide, N,N-diethylacrylamide, oxazolidone-N-ethyl acrylate, methyl acrylate and ethyl acrylate.

3. The article having a micro uneven structure on a surface thereof according to claim 1, wherein the active energy ray curable resin composition contains a polymerizable component (X), a photoinitiator (E), and an internal mold release agent (F);
wherein the polymerizable component (X) contains 30-49.99 mass % of a polyfunctional monomer (A), 30-40 mass % of a bifunctional monomer (B), 20-30 mass % of a monomer (C2) and 0.01-10 mass % of a monomer (D), wherein the polyfunctional monomer (A) has 3 or more free radical polymerizable functional groups in a molecule and each functional group thereof has a molecular weight of 150 or less, the bifunctional monomer (B) has 2 free radical polymerizable functional groups in a molecule and 4 or fewer oxyalkylene groups in the molecule, the monomer (C2) has 1 or more free radical polymerizable functional groups in a molecule and a morpholine skeleton in the molecule, and the monomer (D) has 1 or more free radical polymerizable functional groups in a molecule and a silicone skeleton in the molecule; and
wherein the internal mold release agent (F) contains a (poly)oxyalkylene alkyl phosphate compound.

4. The article having a micro uneven structure on a surface thereof according to claim 1, wherein the active energy ray curable resin composition contains a polymerizable component (X), a photoinitiator (E), and an internal mold release agent (F);
wherein the polymerizable component (X) contains 30-60 mass % of a polyfunctional monomer (A), 20-60 mass % of a bifunctional monomer (B), 5-30 mass % of a monomer (C3) and 0.01-10 mass % of a monomer (D), wherein the polyfunctional monomer (A) has 3 or more free radical polymerizable functional groups in a molecule and each functional group thereof has a molecular weight of 150 or less, the bifunctional monomer (B) has 2 free radical polymerizable functional groups in a molecule and 4 or fewer oxyalkylene groups in the molecule, the monomer (C3) has 1 or more acrylamide groups in a molecule, and the monomer (D) has 1 or more free radical polymerizable functional groups in a molecule and a silicone skeleton in the molecule; and
wherein the internal mold release agent (F) contains a (poly)oxyalkylene alkyl phosphate compound.

5. The article having a micro uneven structure on a surface thereof according to claim 1, wherein the article is an antireflective article.

6. A video display device, comprising:
a video display device main body; and
one or more of the article having a micro uneven structure on a surface thereof according to claim 1, disposed at a front of a screen of the video display device main body.

7. A video display device, comprising:
a video display device main body; and
one or more of the article having a micro uneven structure on a surface thereof according to claim 2, disposed at a front of a screen of the video display device main body.

8. A video display device, comprising:
a video display device main body; and
one or more of the article having a micro uneven structure on a surface thereof according to claim 3, disposed at a front of a screen of the video display device main body.

9. A video display device, comprising:
a video display device main body; and
one or more of the article having a micro uneven structure on a surface thereof according to claim 4, disposed at a front of a screen of the video display device main body.

10. A video display device, comprising:
a video display device main body; and
one or more of the article having a micro uneven structure on a surface thereof according to claim 5, disposed at a front of a screen of the video display device main body.

11. The article having a micro uneven structure on a surface thereof according to claim 2, wherein the article is an antireflective article.

12. The article having a micro uneven structure on a surface thereof according to claim 3, wherein the article is an antireflective article.

13. The article having a micro uneven structure on a surface thereof according to claim 4, wherein the article is an antireflective article.

14. A video display device, comprising:
a video display device main body; and
one or more of the article having a micro uneven structure on a surface thereof according to claim 11, disposed at a front of a screen of the video display device main body.

15. A video display device, comprising:
a video display device main body; and
one or more of the article having a micro uneven structure on a surface thereof according to claim 12, disposed at a front of a screen of the video display device main body.

16. A video display device, comprising:
a video display device main body; and
one or more of the article having a micro uneven structure on a surface thereof according to claim 13, disposed at a front of a screen of the video display device main body.
